(19) United States
(12) Patent Application Publication
(10) Pub. No.: US 2003/0014493 A1
(43) Pub. Date: Jan. 16, 2003

(54) Linkage system for medical institutions

(75) Inventors: Toshiyuki Sakurai, Gifu-shi (JP); Nobuaki Nii, Ogaki-shi (JP); Takashi Sugiyama, Hashima-shi (JP); Masatoshi Nonogaki, Hashima-gun (JP); Akiko Inami, Hashima-gun (JP); Atsushi Furukawa, Anpachi-gun (JP)

Correspondence Address: ARMSTRONG,WESTERMAN & HATTORI, LLP, 1725 K STREET, NW., SUITE 1000, WASHINGTON, DC, 20006, US

(73) Assignee: Sanyo Electric Co., Ltd., Moriguchi-shi (JP)

(21) Appl. No.: 09/987,017

(22) Filed: Nov. 13, 2001

(30) Foreign Application Priority Data
Jul. 13, 2001 (JP) 2001-213553
Jul. 13, 2001 (JP) 2001-213277

(51) Int. Cl. G06F 15/16; G06F 17/60

(52) U.S. Cl. 709/206; 705/2

(57) ABSTRACT

There is a hospital-clinic linkage system which links a plurality of clinic systems 10(i) and a hospital system 20 to each other through the Internet.

In this hospital-clinic linkage system, inquiring e-mails, each of which contains medical data of a patient, are sent from the clinic systems 10(i) to the hospital system 20 respectively, and answers to such inquiring e-mails are sent from the hospital system 20 to each of the clinic systems 10(i) to assist the medical treatment acts by the clinics.

Each clinic system 10(i) has a function as a computerized patient record (CPR) system and a linkage function to the hospital system 20. The hospital system 20 has a linkage function to each clinic system 10(i).

### BACKGROUND OF THE INVENTION

1. Field of the Invention

This invention generally relates to a linkage or communication system for medical institutions. The linkage system links the computer systems of a plurality of medical institutions to each other through a network in such a way that data can be sent and received to and from any other computer systems on the network. And this invention more particularly relates to a hospital-clinic linkage system such as one which links comparatively small-sized clinics to a comparatively large-sized hospital.

2. Prior Art

As it is prevailing that electronic mails (e-mails) are sent and received through the Internet, it is presumed to be a matter of course that medical doctors personally create documents related to their medical treatment and send and receive these medical documents to and from other medical doctors in the form of file attached to their e-mails.

A computer system equipped with a function of a computerized patient record (CPR) system or a function of an electronic chart. Here, the function of the CPR system or the electronic chart refers to a function of configuring the database of medical treatment data by digitizing and transferring medical treatment data recorded on a patient record sheet to a hard disk or other medium, and reading, processing or doing the like and utilizing this recorded medical treatment data as the need arises.

### SUMMARY OF THE INVENTION

It is demanded that the quality of medical treatment by medical institutions should be improved by sending and receiving medical treatment data on a CPR system to and from others among a plurality of medical institutions so that excellent medical treatment service can be provided. The primary objective of the present invention is to satisfy this demand.

It is also demanded that the quality of medical treatment by medical institutions should be improved by sending and receiving inquiring e-mails attached with medical treatment data and answering e-mails in reply to such received inquiring e-mails to and from others among a plurality of medical institutions so that excellent medical treatment service can be provided. To satisfy this demand, it is required that the inquiring e-mails and the answering e-mails to such inquiring e-mails can be completely controlled without failing in mutual correspondence therebetween. Another objective of the present invention is to satisfy this demand.

This invention relates to a medical institution linkage or communication system which links the computer systems of a plurality of medical institutions to each other through a network in such a way that data can be sent and received to and from any other computer systems on the network. In this medical institution linkage or communication system, a computer system of an inquiring medical institution comprises a file creating means for creating basic data files of a predetermined format having patient data and inquiry contents and medical treatment data files of a predetermined format based on the medical treatment data of the patient specified by such patient data, an e-mail creating means for creating an e-mail having such basic data files and medical treatment data files as attachment files and addressing to a predetermined computer system of a predetermined answering medical institution, and a communication terminal for sending out such e-mail to the network. On the other hand, such computer system of such answering medical institution comprises an output means for outputting the contents of the attachment files attached to an e-mail received from the network in a mode recognizable to human eyes, a file creating means for creating reply data files of a predetermined format having the contents of answers to the contents of inquiries contained in such attachment files, an e-mail creating means for creating an e-mail having such reply data files in a form of attachment file and addressing to such computer system of such inquiring medical institution, and a communication terminal for sending out such e-mail to the network.

The patient data and the medical treatment data can be acquired from information sources such as the database of medical treatment data of CPR system.

When the basic data files and medical treatment data files created by the file creating means of the computer systems of the inquiring medical institution take a file format suitable to be displayed on a general-purpose browser (e.g., HTML format, XML format suitable to conversion to HTML format), the computer system of the answering medical institution can display the received attachment files on a general-purpose browser without installing any special-purpose application for displaying the received attachment files.

This is also the case with the file format of the reply data files created by the file creating means of the computer system of the answering medical institution.

Here, the output in a mode recognizable to human eyes refers to output such as output to a display or output to a printer. However, instead of or in combination with such output mode, output in a voice may be adopted.

The Internet may be adopted as a network. However, instead of the Internet, a dedicated network linking selected medical institutions may be adopted. When the Internet is adopted, a security means known to the public such as Virtual Private Network (VPN) may be adopted to ensure the security.

This invention also relates to a computer system of an answering medical institution in a medical institution linkage or communication system which links the computer systems of a plurality of medical institutions to each other through a network in such a way that data can be sent and received to and from any other computer systems on the network. In this medical institution linkage or communication system, a computer system of an answering medical institution comprises an output means for outputting attachment files attached to an e-mail received from the network in a mode recognizable to human eyes, a file creating means for creating reply data files of a predetermined format having contents of answers to contents of inquiries contained in such attachment files, an e-mail creating means for creating an email having such reply data files in a form of attachment file and addressing to a predetermined computer system of a predetermined inquiring medical institution that have sent out such e-mail, and a communication terminal for sending out such created e-mail to the network.

This invention also relates to a medical institution linkage or communication method. In this linkage method, a computer system of an inquiring medical institution creates the basic data files of a predetermined format having patient data and inquiry contents and medical treatment data files of a predetermined format based on the medical treatment data of the patient specified by such patient data, creates an e-mail with such basic data files and medical data files as attachment files and addressing to a computer system of a predetermined answering medical institution, and sends out such e-mail to the network. On the other hand, such computer system of such answering medical institution outputs the contents of the attachment files attached to the e-mail received from the network in a mode recognizable to human eyes, creates the reply data files of a predetermined format having the contents of answers to the contents of the inquiries contained in such attachment files, creates an e-mail having such reply data files in a form of attachment file and addressing to the computer systems of such inquiring medical institution, and sends out such e-mail to the network.

This invention also relates to a program which allows a computer system of answering medical institution in a medical institution linkage or communication system on a network to function as an output means for outputting contents of attachment files attached to an e-mail received from the network in a mode recognizable to human eyes, a file creating means for creating reply data files of a predetermined format having contents of answers to the contents of the inquiries contained in such attachment files, and an e-mail creating means for creating an e-mail having such reply data files in a form of attachment file and addressing to the computer system which have sent out such inquiring e-mail.

This invention also relates to a medical institution linkage or communication system which links the computer systems of a plurality of medical institutions to each other through a network in such a way that data can be sent and received to and from any other computer systems on the network. In this medical institution linkage or communication system, a computer system of an inquiring medical institution comprises an e-mail creating means for creating an inquiring e-mail having inquiry data files of a predetermined format as attachment files with patient data, inquiry contents and medical treatment data of the patient specified by such patient data, and addressing to a computer system of a predetermined answering medical institution, an e-mail control data setting means for setting unique mail control data to such inquiring e-mail, and a communication terminal for sending out such inquiring e-mail to the network. On the other hand, such computer system of such answering medical institution comprises an e-mail creating means for creating an answering e-mail with reply data files as attachment files having the contents of answers to the contents of inquiries contained in the attachment files attached to the inquiring e-mail received from the network and addressing to the computer system which has sent such inquiring e-mail, an e-mail control data setting means for setting the corresponding e-mail control data to the e-mail control data for the inquiring e-mail on which such answering e-mail is based, and a communication terminal for sending out such answer e-mail to the network. Such computer system of such inquiring medical institution and such computer system of such answering medical institution have an e-mail control means, respectively, for controlling the inquiring e-mail and answering e-mail with which the e-mail control data agree with.

### BRIEF DESCRIPTION OF THE DRAWINGS

FIG. 1 is a block diagram showing a network configuration of a hospital-clinic linkage system according to an embodiment of the present invention;

FIG. 2 is a block diagram showing a configuration of a clinic system 10(i) within the hospital-clinic linkage;

FIG. 3 is a block diagram showing a configuration of a hospital system 20 within the hospital-clinic linkage system;

FIG. 4 is a descriptive table of database of sent data 12b and a descriptive table of database of received data 12c both of the clinic system 10(i);

FIG. 5 is a descriptive table of database of sent data 22b and a descriptive table of database of received data 22c both of the hospital system 20;

FIG. 6 is a patient data table 13a composed on a memory 13 of the clinic system 10(i), and a descriptive table showing a configuration of database of medical treatment and patient data 12a of the clinic system 10(i);

FIG. 7 is a flowchart describing procedure performed by the clinic system 10(i);

FIG. 8 is a flowchart describing procedure performed by the hospital system 20;

FIGS. 9(a) and 9(b) are flowcharts describing processing for linkage system to be performed by the clinic system 10(i);

FIGS. 10(a) and 10(b) are flowcharts describing processing for linkage system to be performed by the hospital system 20;

FIGS. 11 through 20(b) are views illustrating a screen configurations to be displayed on a display unit of the clinic system 10(i), and FIGS. 21 through 28(b) are views illustrating a screen configurations to be displayed on a display unit of the hospital system 20; where

FIG. 11 is a descriptive view illustrating a Inquiry/Reply Mail List screen of the clinic system 10(i);

FIG. 12 is a descriptive view illustrating a tab (1) state of a Sending Data Creation screen (an input screen of basic data (1)) of the clinic system 10(i);

FIG. 13 is a descriptive view illustrating a tab (2) state of a Sending Data Creation screen (an input screen of basic data (2)) of the clinic system 10(i);

FIG. 14 is a descriptive view illustrating a Disease Name Selection screen of the clinic system 10(i);

FIG. 15 is a descriptive view illustrating a Medical Consultation Date Selection screen of the clinic system 10(i);

FIG. 16 is a descriptive view illustrating a Test Result Selection screen of the clinic system 10(i);

FIG. 17 is a descriptive view illustrating a Date Information Input Dialog screen of the clinic system 10(i);

FIG. 18 is a descriptive view illustrating an Image Selection screen of the clinic system 10(i);

FIG. 19 is a descriptive view illustrating a Document Selection screen of the clinic system 10(i);

FIG. 20(a) is a descriptive view illustrating an Inquiry Information Display screen of the clinic system 10(i);

FIG. 20(b) is a descriptive view illustrating a Reply Information Display screen of the clinic system 10(i);

FIG. 21 is a descriptive view illustrating a Inquiry/Reply Mail List screen of the hospital system 20;

FIG. 22 is a descriptive view illustrating a Sending Data Creation screen of the hospital system 20;

FIG. 23 is a descriptive view illustrating an initial display of an Attachment Data Selection screen of the hospital system 20;

FIG. 24 is a descriptive view illustrating the Attachment Data Selection screen after pressing the IMAGE button and then DOCUMENT button;

FIG. 25 is a descriptive view illustrating the Attachment Data Selection screen after selecting desirable images and documents as attachment files;

FIG. 26 is a descriptive view illustrating an Attachment Data Addition screen for adding new attachment data to the Attachment Data Selection screen;

FIG. 27 is a descriptive view illustrating the Attachment Data Selection screen after adding new attachment data from the Attachment Data Addition screen;

FIG. 28(a) is a descriptive view illustrating an Inquiry Information Display screen of the hospital system 20;

FIG. 28(b) is a descriptive view illustrating a Reply Information Display screen of the hospital system 20; and

FIG. 29 is an another example of a descriptive table of database of sent and received data of the hospital system 20.

### EMBODIMENT

This invention will be described hereinafter referring to a hospital-clinic linkage system which links the computer systems of a plurality of clinics (hereinafter referred to as “clinic systems”) and the computer system of one hospital (hereinafter referred to as “hospital system”) to each other through the Internet. Here, a clinic refers to a comparatively small-sized medical institution, and a hospital refers to a comparatively large-sized medical institution. In this hospital-clinic linkage system, inquiring e-mails, each of which contains medical data (medical treatment data, medical observation data, complaint, etc.,) of a patient, are sent from the clinic systems to the hospital system respectively, and answers to such inquiring e-mails are sent from the hospital system to each of the clinic systems to assist the medical treatment acts by the clinics.

[1] Outline of the Hospital-Clinic Linkage System

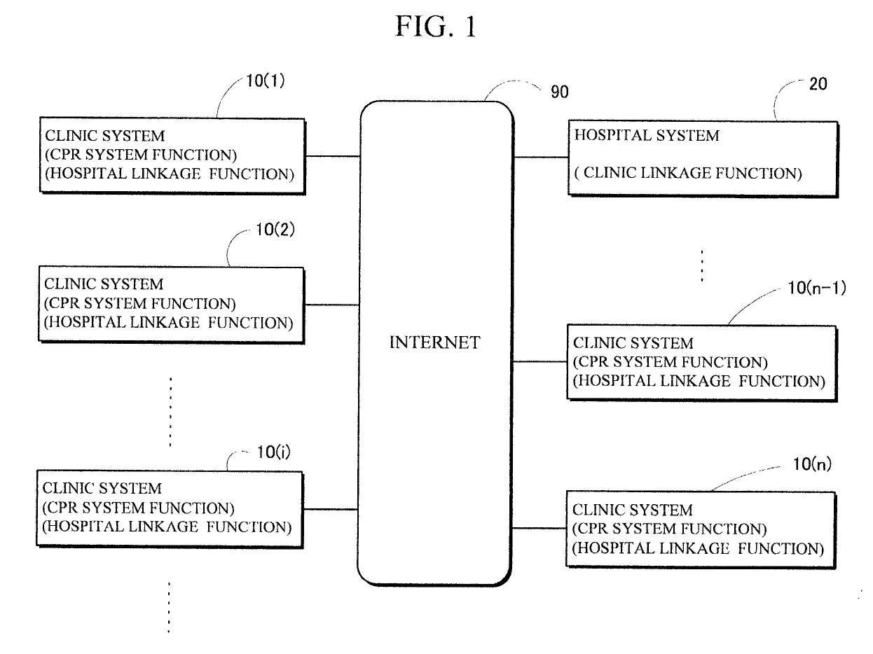

FIG. 1 is a descriptive diagram of a network configuration of a hospital-clinic linkage system according to an embodiment of the present invention. According to the hospital-clinic linkage system shown in FIG. 1, a plurality of clinic systems 10(1), 10(2), . . . 10(n) and one hospital system 20 are linked through the Internet in such a way that data can be sent and received to and from each other.

Each clinic system 10 has at least a function as a computerized patient record (CPR) system (hereinafter referred to as “CPR system function”) or an electronic chart function and a linkage function to a hospital system 20 (hereinafter referred to as “hospital linkage function”), and furthermore a function as a communication terminal to be connected to the Internet (hereinafter referred to as “terminal function”). Each clinic system 10 may access to the Internet by constant connections or by dial-up as the need arises.

The CPR system function of each clinic system 10 allows medical treatment data to be recorded in database of medical data and the recorded medical treatment data to be read and utilized as the need arises. Here, “utilization” refers to, e.g., displaying the medical treatment data in a Chart No. 2 screen of the CPR System, which is designed after the patient record sheet No. 2, arranging the medical treatment data items of the same medical treatment receiving date (same medical consultation date) in one column and the medical treatment data items of the same item in one line and displaying such arranged medical treatment data in a Time-Series screen of the CPR System or other similar act. Recording/reading of the medical treatment data by the CPR system to/from the database of medical treatment data is performed by specifying a patient and, if necessary, a date or period (date range).

The hospital linkage function of each clinic system 10 refers to a function of sending inquiries which may contain medical treatment data to the hospital system 20 by e-mail, receiving answers thereto from the hospital system 20 by e-mail, and integrally controlling both inquiring e-mails and answering e-mails thereto. Here, “integrally controlling both inquiring e-mails and answering e-mails thereto” refers to, e.g., being able to read ones from corresponding others directly and to display them in pairs, or to protect unanswered inquiring e-mails from being deleted, or other similar act.

The hospital system 20 has at least a linkage function to each clinic system 10 (hereinafter referred to as “clinic linkage function”), and furthermore a function as a communication terminal to be connected to the Internet (hereinafter referred to as “terminal function”). The mode of connection between the hospital system 20 and the Internet should preferably be of continuous connections type in view of the necessity of the hospital system 20 to quickly answer inquiring e-mails upon receipt from a plurality of clinic systems 10.

The clinic linkage function of the hospital system 20 contains at least a function of outputting the contents of inquiring e-mails from the clinic systems 10 as display or the like, assisting a user to create answers to the inquiries, and sending such answers to the clinic systems 10, and a function of integrally controlling both inquiring e-mails and answering e-mails thereto.

[2] Configuration of the Clinic System 10

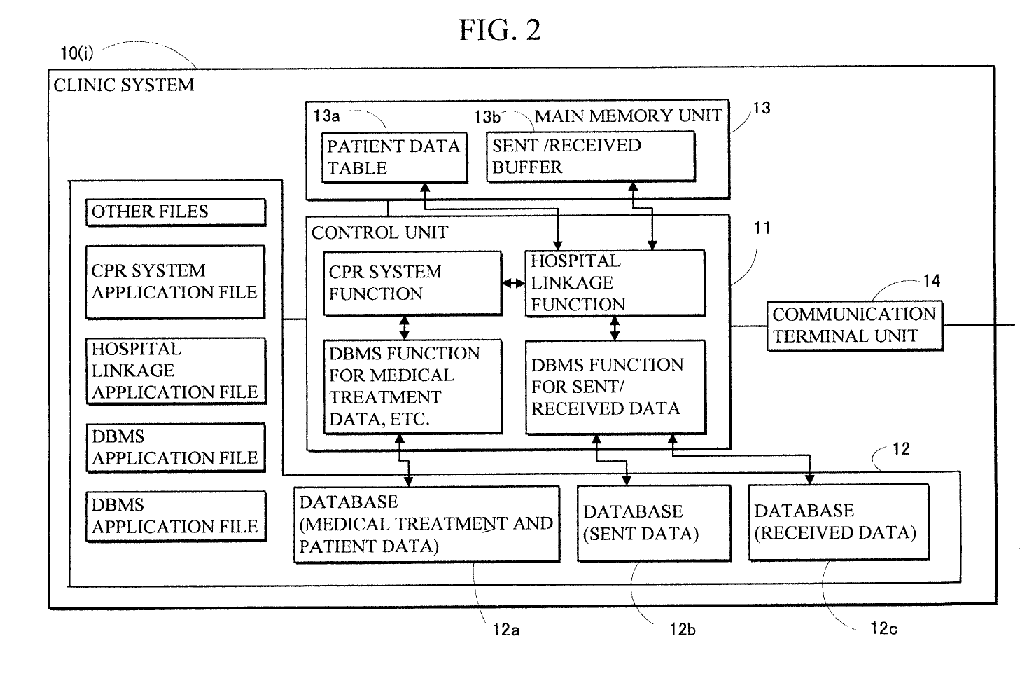

FIG. 2 shows an example of the configuration of the clinic system 10(i) having the above-described functions (CPR system function, hospital linkage function, terminal function). As shown in FIG. 2, the clinic system 10 has a control unit (CPU) 11, an auxiliary storage unit (hard disk) 12, a main memory unit (memory) 13 and a communication terminal unit 14. Furthermore, though not illustrated in this figure, a display unit (display), a printing unit (printer) and other peripheral units are connected to the clinic system 10. Also, the clinic system 10, which is illustrated as a stand-alone computer system in FIG. 2, may be a system in connection through the local area network (LAN).

The CPR system function is realized by reading a CPR system application from the hard disk 12 and running such CPR system application. The CPR system function allows the record/read of the medical treatment data and patient data to be performed with database 12a of medical treatment and patient data within the hard disk 12. Such record/read is realized when the CPR system function issues a command to a database management system (DBMS) for medical treatment data etc., and at such command, the DBMS for medical treatment data etc. performs the record/read of the data of the database 12a of medical treatment data and patient data and returns the results to the CPR system function. It should be noted here that the record/read of the records of the database 12a of medical treatment data and patient data is performed by utilizing the patient ID as a key or the patient ID and medical treatment receiving date or period (medical consultation date or period) as a key.

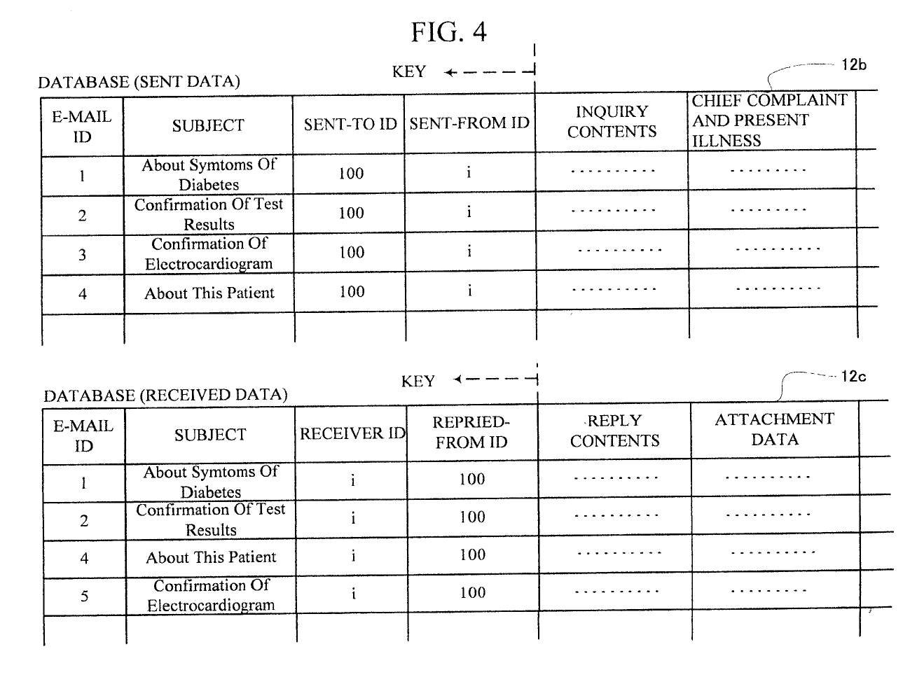

The hospital linkage function is realized by reading a hospital linkage application file from the hard disk 12 and running such hospital linkage application. The hospital linkage function performs the record/read of the sent data and received data with the database 12b of sent data and database 12c of received data within the hard disk 12. Such record/read is realized when the hospital linkage function issues a command to the database management system (DBMS) for medical treatment data etc., and at such command, the DBMS for medical treatment data etc. performs the record/read of the data of the database 12b of sent data and database 12c of received data and returns the results to the hospital linkage function. FIG. 4 shows an example of the configuration of the database 12b of sent data and database 12c of received data. As shown in FIG. 4, the record of the database 12b of sent data and the record of the database 12c of received data corresponding thereto are correspondingly controlled with the e-mail ID, subject, sent-to ID (corresponding to replied-from ID) and sent-from ID (corresponding to receiver ID) as a combined key.

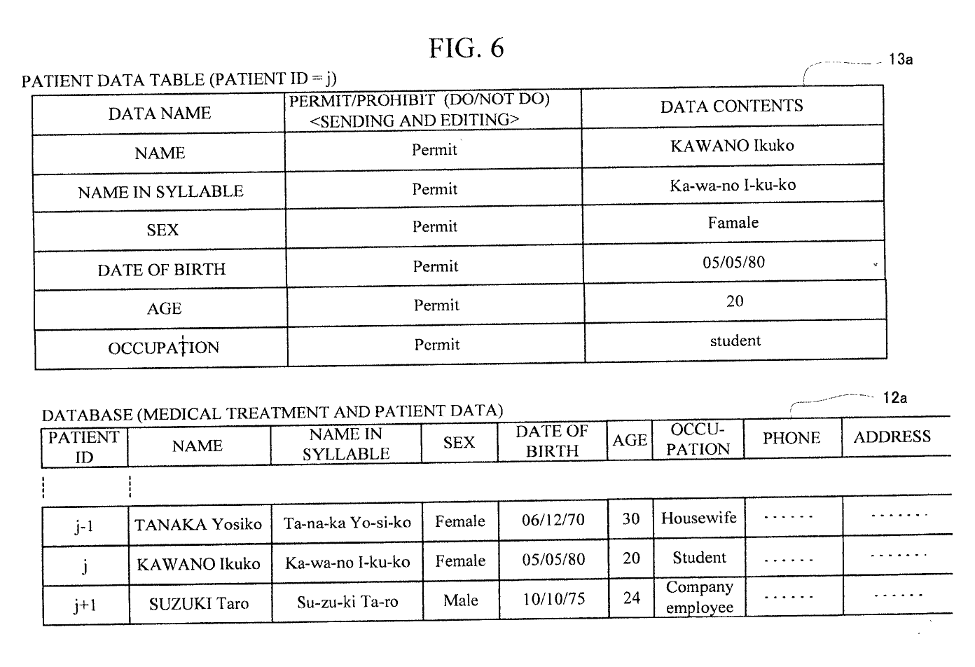

Patient data table 13a is composed on the memory 13 when inquiry data is created. This patient data table 13a controls the permission/prohibition (do/not do) of sending of each patient data item, and controls the permission/prohibition (do/not do) of amending of each patient data item. An example of such patient data table 13a is shown in FIG. 6, and the details of such patient data table 13a will be described later. “Other files saved in the hard disk 12” refers to a group of files together which are not directly related to this invention.

[3] Configuration of the Hospital System 20

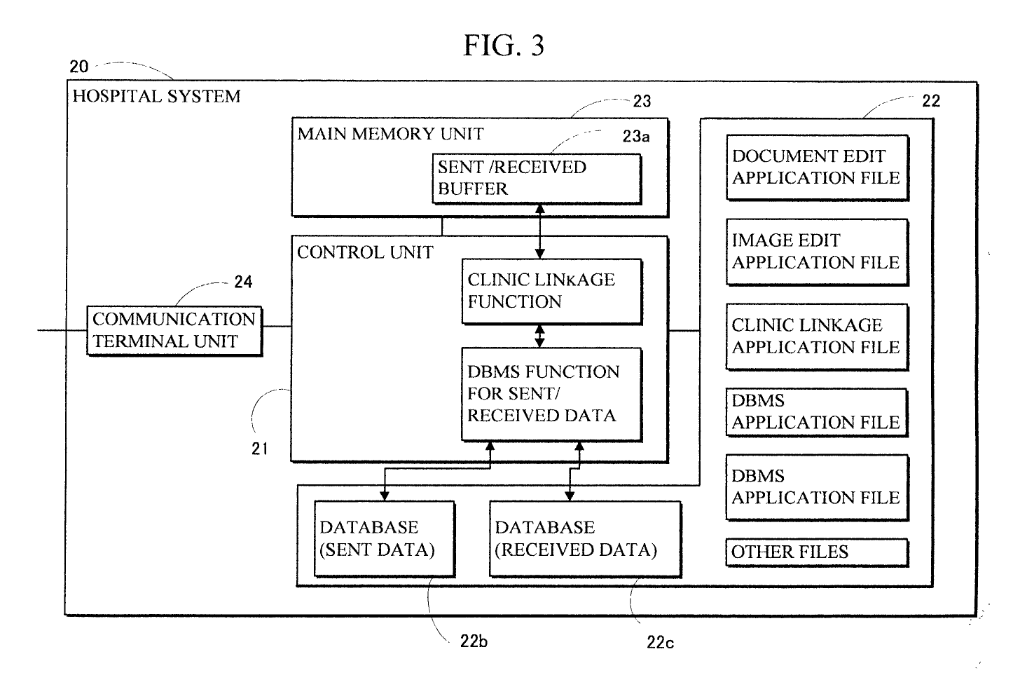

FIG. 3 shows an example of the configuration of the hospital system 20 having the above-described functions (clinic linkage function, terminal function). As shown in FIG. 3, the hospital system 20 comprises a control unit (CPU) 21, an auxiliary storage unit (hard disk) 22, a main memory unit (memory) 23 and a communication terminal unit 24. Furthermore, though not illustrated in this figure, a display unit (display), a printing unit (printer) and other peripheral units are connected to the hospital system 20. The hospital system 20 is illustrated as a stand-alone computer system in FIG. 3, but may be a system connected to the local area network (LAN).

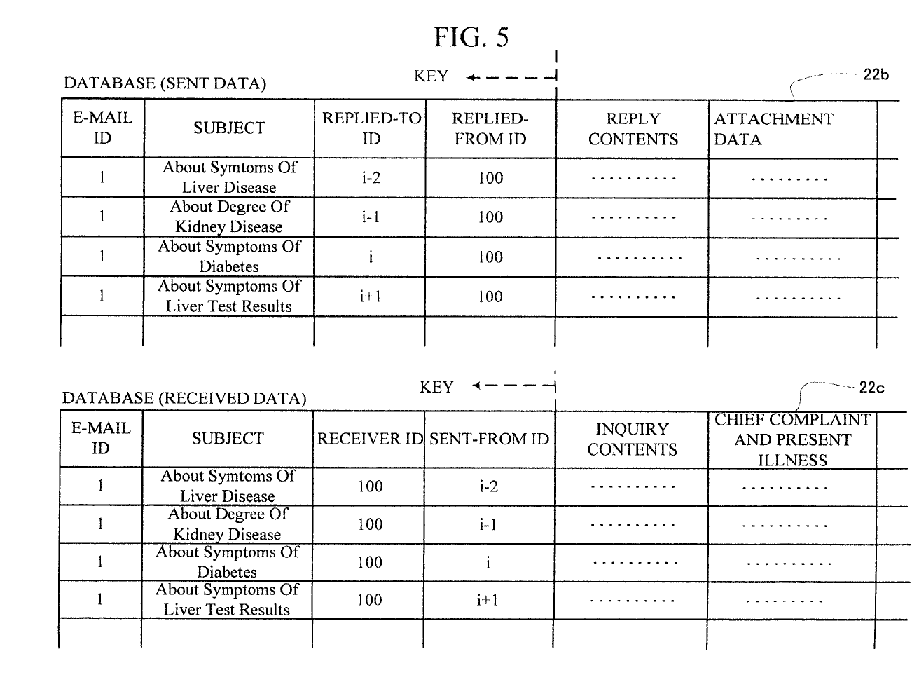

The clinic linkage function is realized by reading a clinic linkage application file from the hard disk 22 and running such clinic linkage application. The clinic linkage function allows the record/read of the sent data and received data with the database 22b of sent data and database 22c of received data within the hard disk 22. Such record/read is realized when the clinic linkage function issues a command to the database management system DBMS for medical treatment data etc., and at such command, the DBMS for medical treatment data etc. performs the record/read of the data of the database 22b of sent data and database 22c of received data, and returns the results to the clinic linkage function. An example of the configuration of the database 22b of sent data and database 22c of received data is shown in FIG. 5. As shown in this figure, the record of the database 22b of sent data and the record of the database 22c of received data corresponding thereto are correspondingly controlled with the e-mail ID, subject, replied-to ID (corresponding to sent-from ID) and replied-from ID (corresponding to receiver ID) as a combined key. It should be noted here that the replied-to ID (corresponding to sent-from ID) of the hospital system 20 is corresponding to the receiver ID (corresponding to sent-from ID) of the clinic system 10, and the replied-from ID (corresponding to receiver ID) of the hospital system 20 is corresponding to the replied-from ID (corresponding to send-to ID) of the clinic system 10.

A document edit application file and an image edit application file are automatically read from the hard disk 22 and started in relation to the documents or images to be attached to reply data when such documents or images are edited. Details of such document edit application and image edit application will be described later. “Other files saved in the hard disk 22” refers to a group of files together which are not directly related to this invention.

[4] Processing Procedure in the Clinic System 10

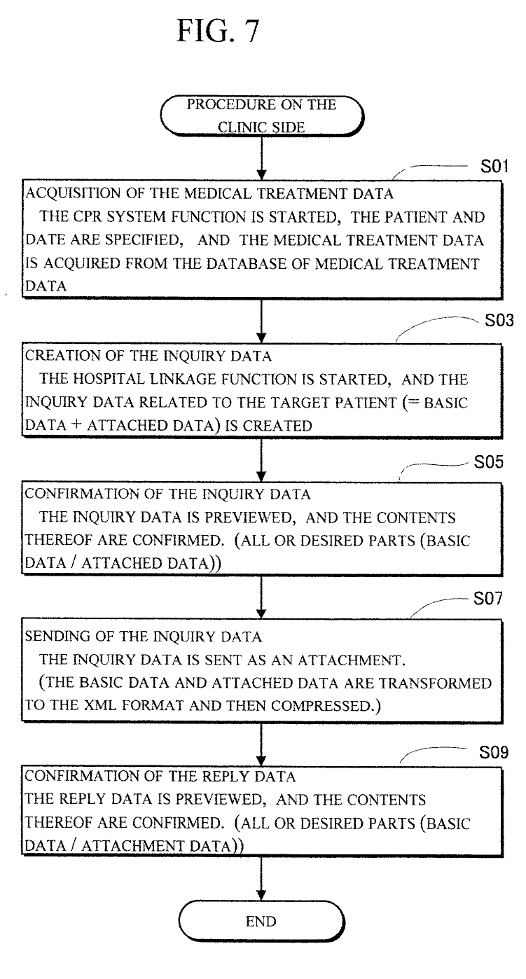

Processing procedure in the clinic system 10 will be described referring to FIG. 7.

[4-1] Acquisition of the Medical Treatment Data (S01)

First of all, the CPR system function is started, and the desired medical treatment data of a desired patient (target patient) is acquired. That is, the CPR system function delivers the patient and date (or date range) specified by operation input to the DBMS for medical treatment data etc. In response thereto, the DBMS reads the medical treatment data of such date (or date range) of such patient from database 12a of medical treatment and patient data, and returns such medical treatment data to the CPR system function. Thereby, the CPR system function displays such medical treatment data in the Chart No. 2 screen of the CPR System or in the Time-Series screen of the CPR System.

[4-2] Creation of the inquiry data (S03)

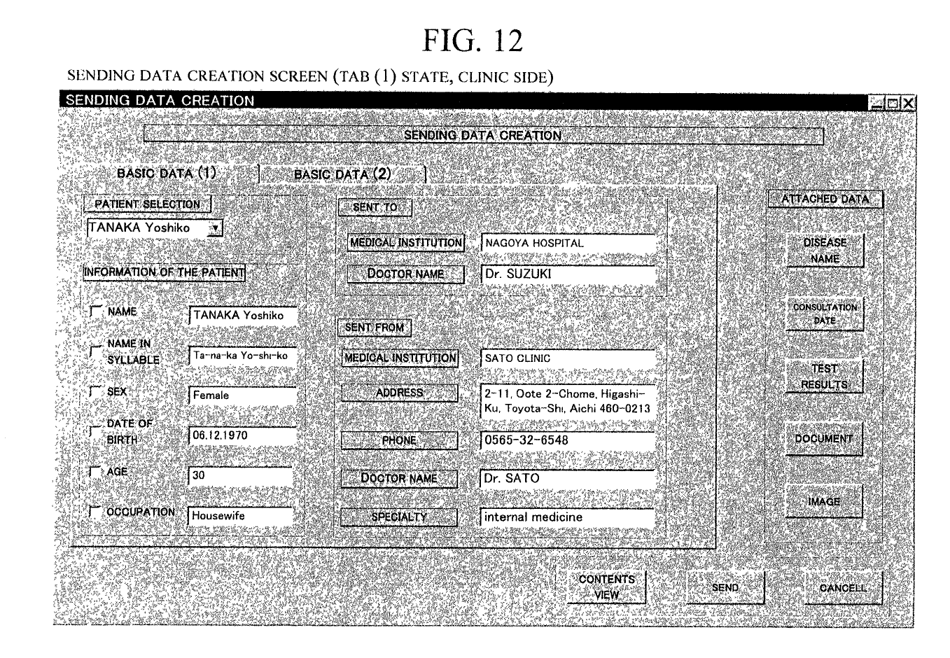

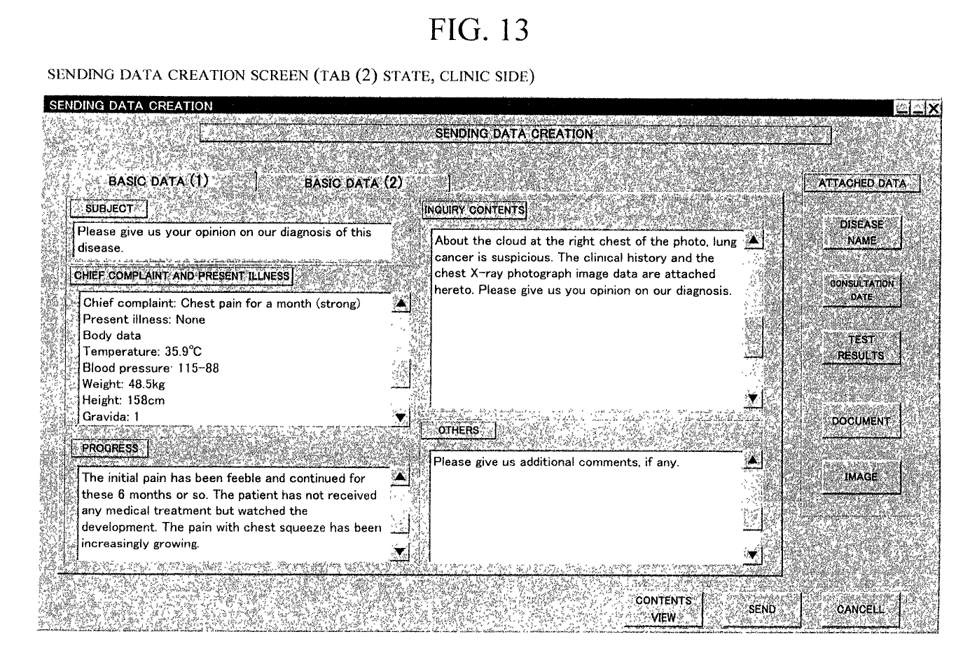

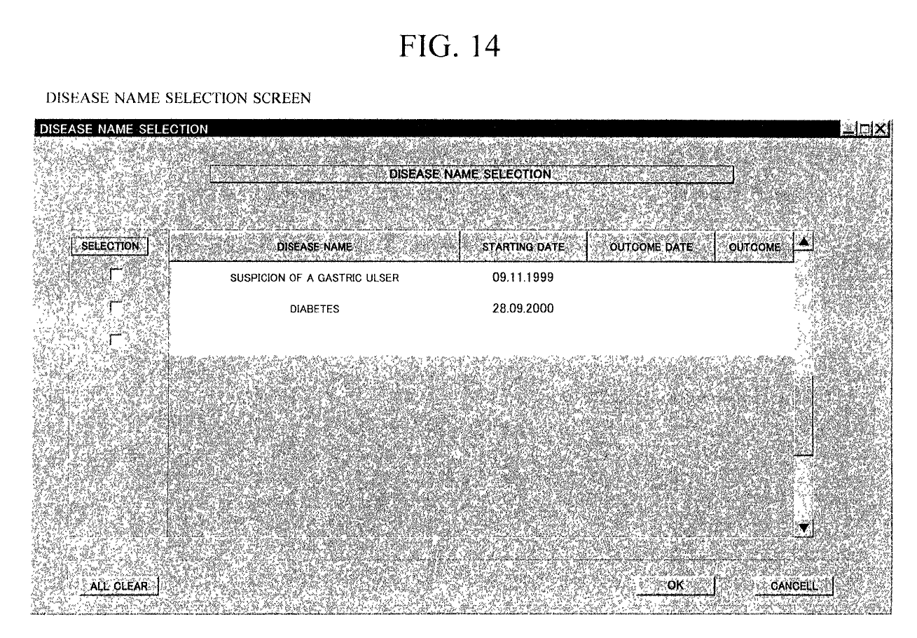

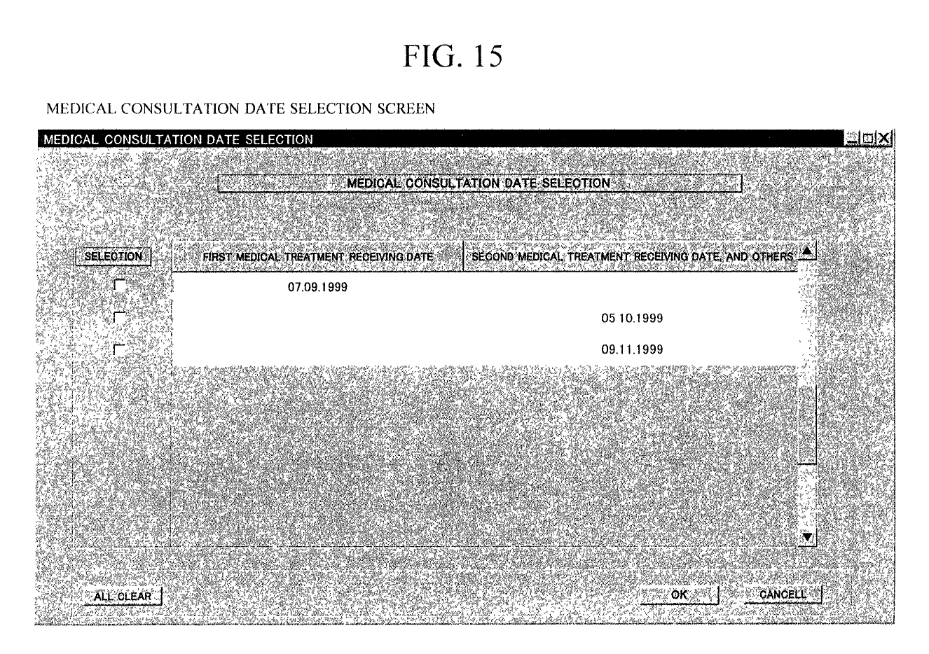

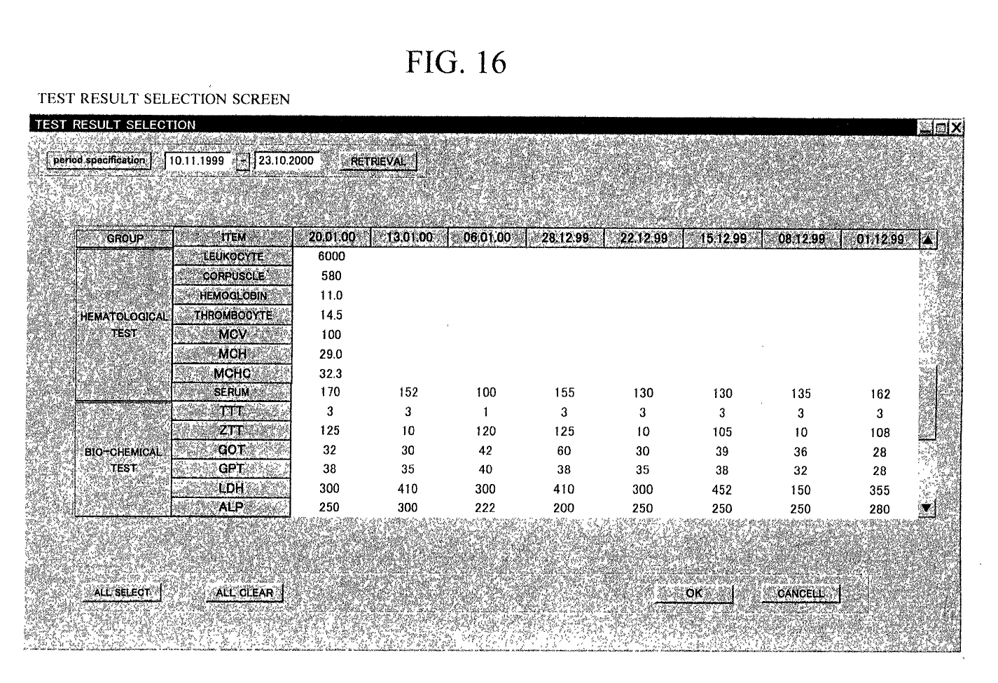

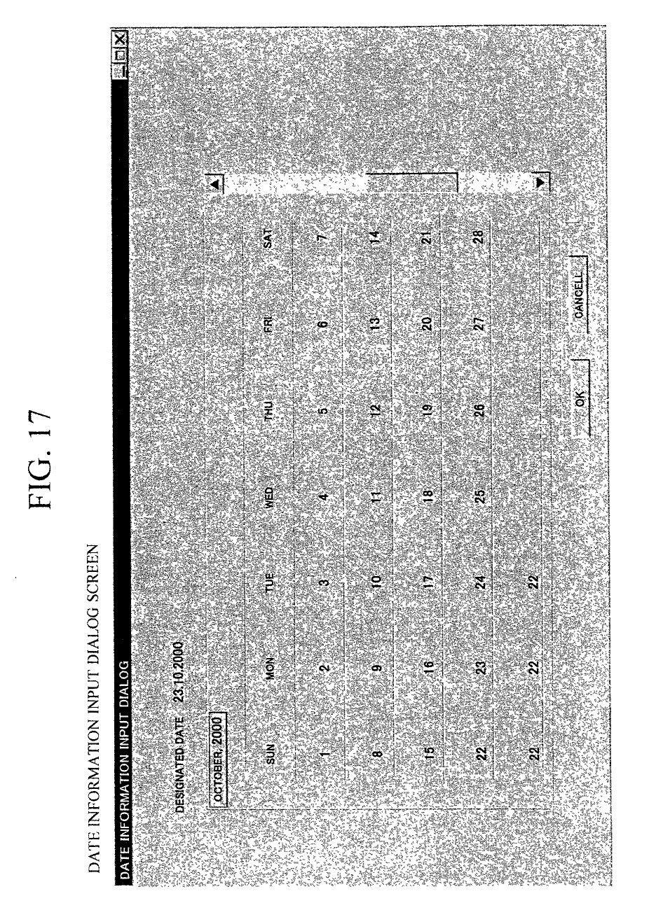

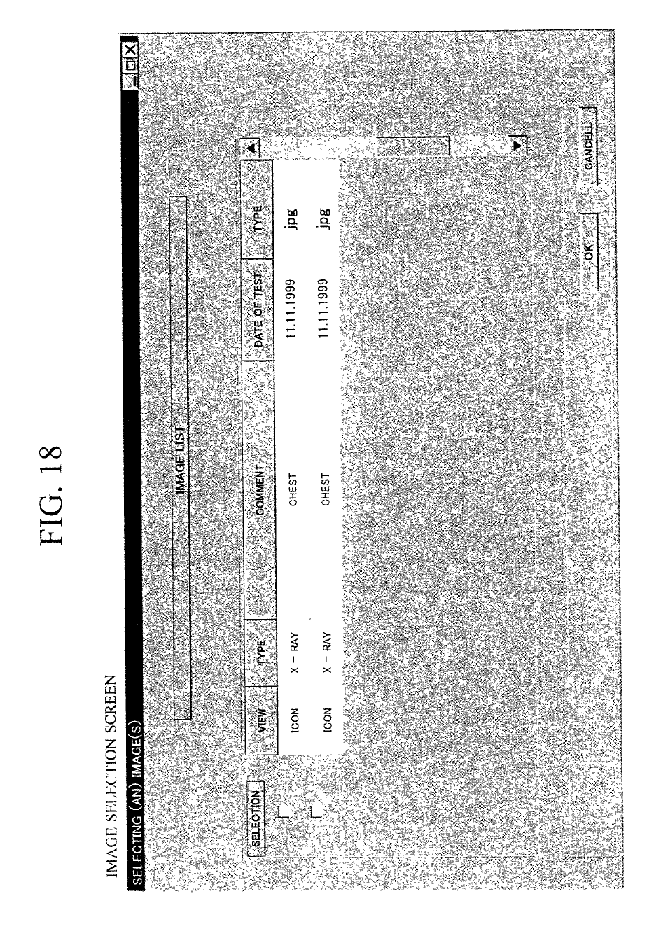

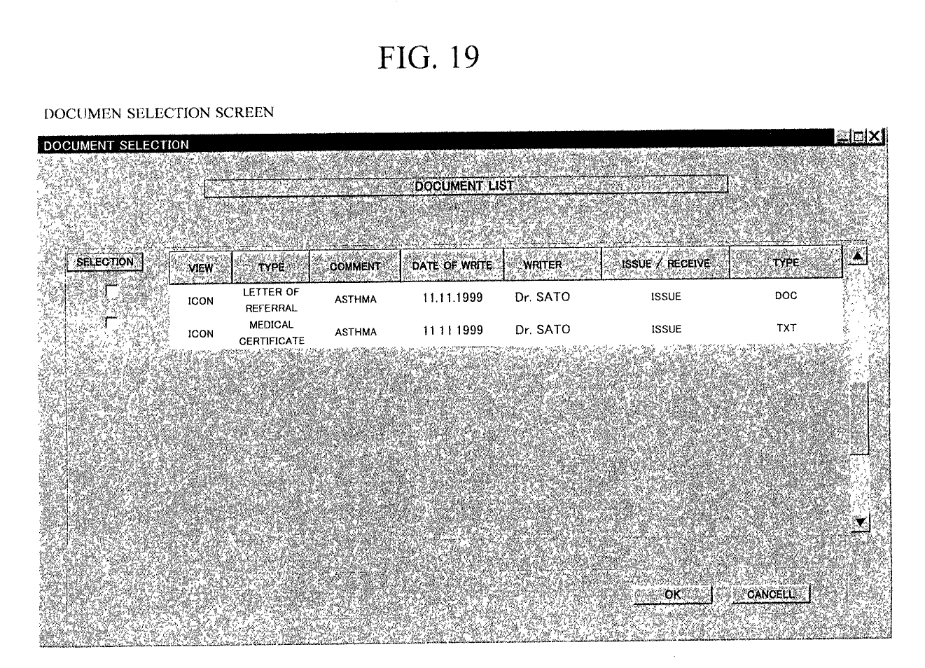

Then, the hospital linkage function is started from each screen of the CPR system (Chart No. 2 screen, Time-Series screen, etc.,). The hospital linkage function executes processing in response to operation input from each screen provided by the hospital linkage function. Here, the screens provided by the hospital linkage function are e.g., Sending Data Creation screen of FIGS. 12 and 13, Disease Name Selection screen of FIG. 14, Medical Consultation Date Selection screen of FIG. 15, Test Result Selection screen of FIG. 16, Date Information Input Dialog screen of FIG. 17, Image Selection screen of FIG. 18, and Document Selection screen of FIG. 19. These screens of FIGS. 14 through 19 are entered from the screen of FIG. 12 or FIG. 13.

By executing the above processing, the inquiry data about the target patient is created and saved in the memory 13. Such inquiry data comprises the basic data set from the Sending Data Creation screen (shown in FIGS. 12 and 13)) and the medical treatment data selected in each selection screen (shown in FIGS. 14 through 19) for attachment as the need arises.

[4-3] Confirmation of the Inquiry Data (S05)

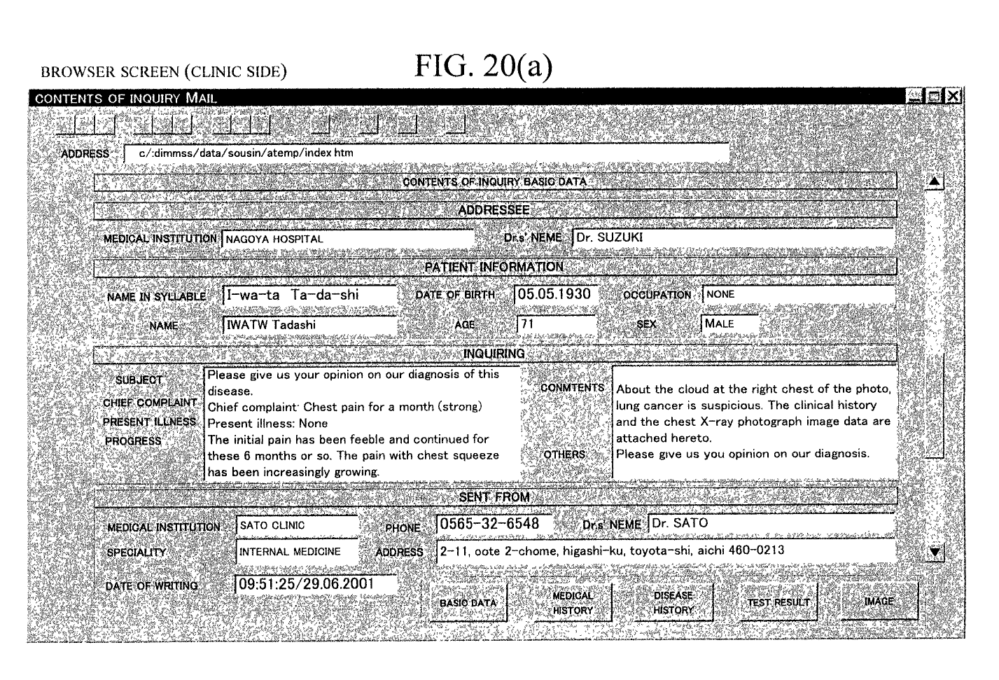

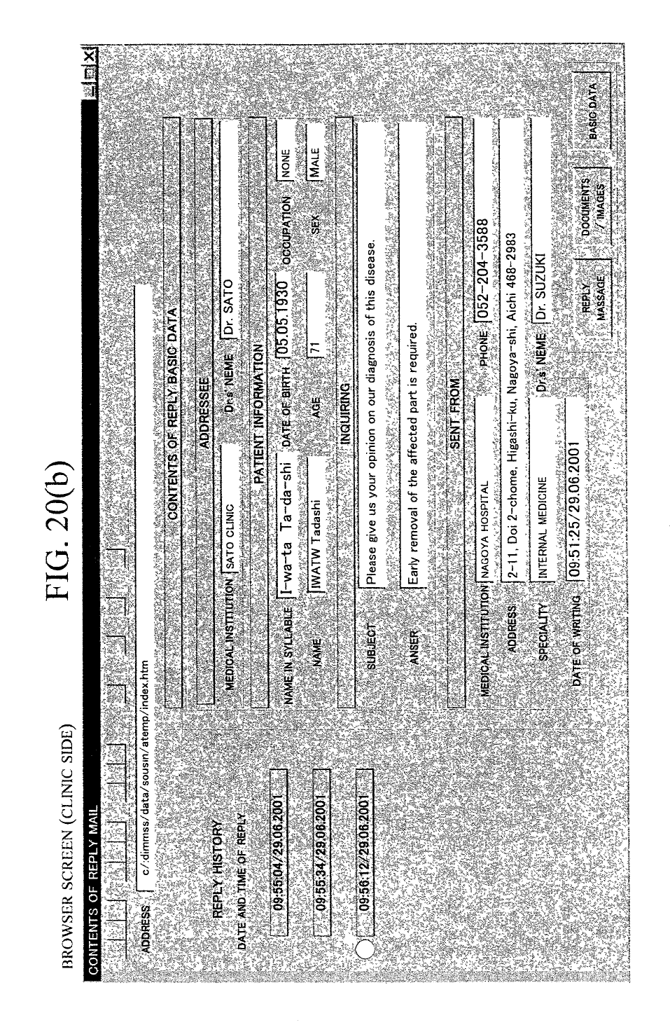

The inquiry data is converted into a file of the XML format in response to operation input commanding the display of the contents. Then, the converted file is processed by using the XSL file, and the contents thereof are displayed in the browser (e.g., Internet Explorer) screen. For example, when the display of the contents is commanded in the Sending Data Creation screen of FIG. 12 or FIG. 13, the contents of the basic data, which is included in the inquiry data, are displayed, and at the same time, button switches for displaying the contents of each attachment data are displayed in the lower part of the browser screen (refer to FIG. 20(a)). On the other hand, when the display of the contents is commanded in one of the selection screens (Disease Name Selection screen of FIG. 14, Medical Consultation Selection Screen of FIG. 15, Test Result Selection screen of FIG. 16, Image Selection Screen of FIG. 18, or Document Selection Screen of FIG. 19), the contents of the selected data to be attached to the basic data are displayed.

[4-4] Sending of the Inquiry Data (S07)

The basic data and each attachment data, which compose the inquiry data, are converted into files of the XML format, respectively, in response to operation input commanding sending, compressed together, and sent as an attachment file to an e-mail to the addressee, i.e., the hospital system 20. This e-mail has the e-mail ID, subject, sent-to ID and sent-from ID as control data. The hospital linkage function of the clinic system 10(i) in this embodiment has one addressee. However, it may be so configured that a plurality of addressees are made available and one addressee is selected from thereamong.

[4-5] Confirmation of the Reply Data (S09)

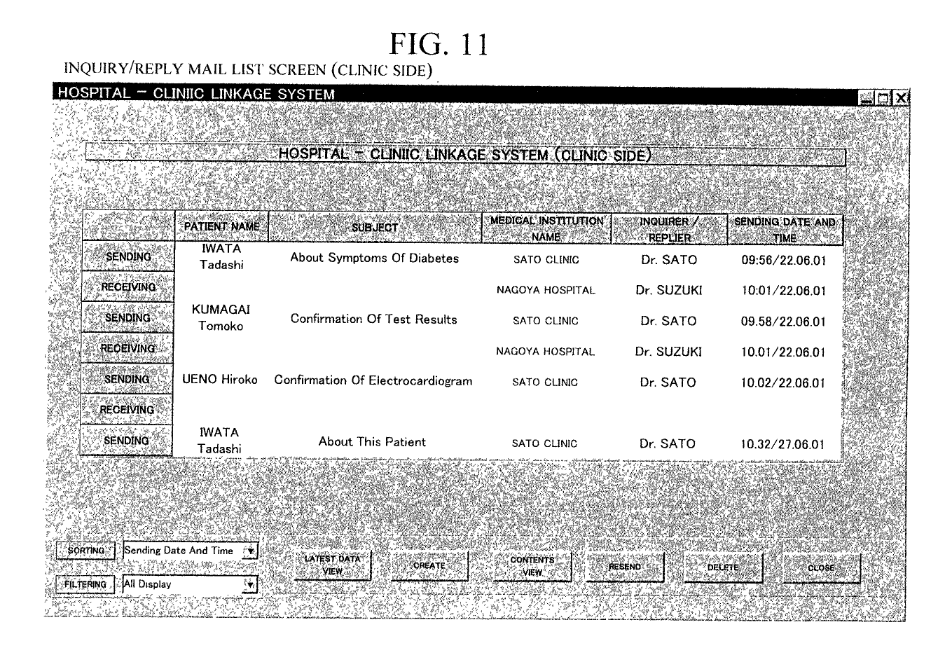

When the reply data is selected and display thereof is commanded in the Inquiry/Reply Mail List screen (refer to FIG. 11) provided by the hospital linkage function, the contents of the basic data, which is included in such reply data, are displayed in the browser (e.g., Internet Explorer) screen, and at the same time, button switches for displaying each attachment data are displayed in the lower part of the browser screen (refer to FIG. 20(b)). When there are two or more reply data whose control data such as the e-mail ID agree with each other, the sent date and time of each reply data is displayed in the left column of the browser screen as reply history (refer to FIG. 20(b)), and the basic data of the reply data selected thereamong is displayed.

[5] Processing Procedure in the Hospital System 20

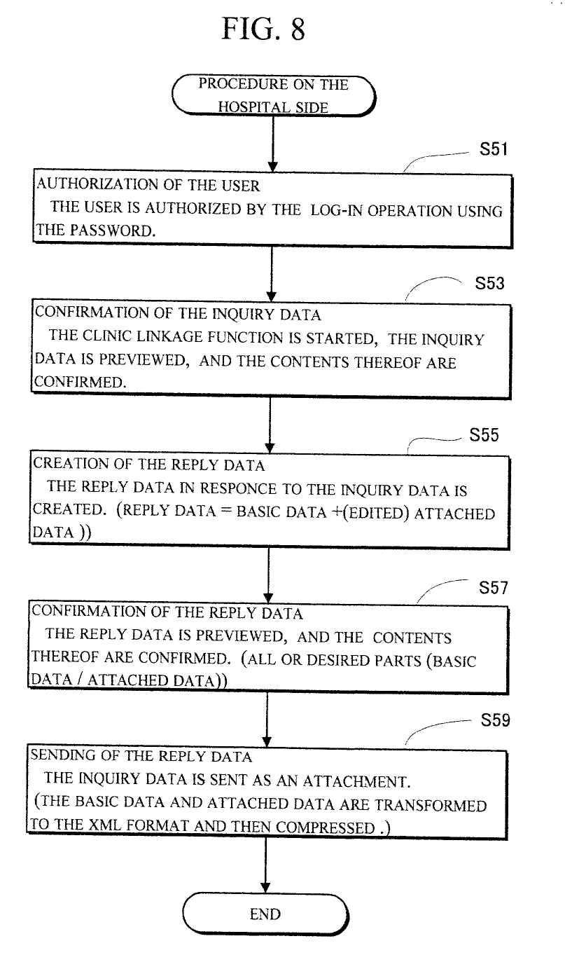

Processing procedure in the hospital system 20 will be described referring to FIG. 8.

[5-1] Authorization of the User (S51)

When startup operation input of the clinic linkage function is performed, a User Authorization screen is displayed. When user selection and password input are performed and the LOG-IN button is pressed in this User Authorization screen, the clinic linkage function is started by the log-in operation by such user.

[5-2] Confirmation of the Inquiry Data (S53)

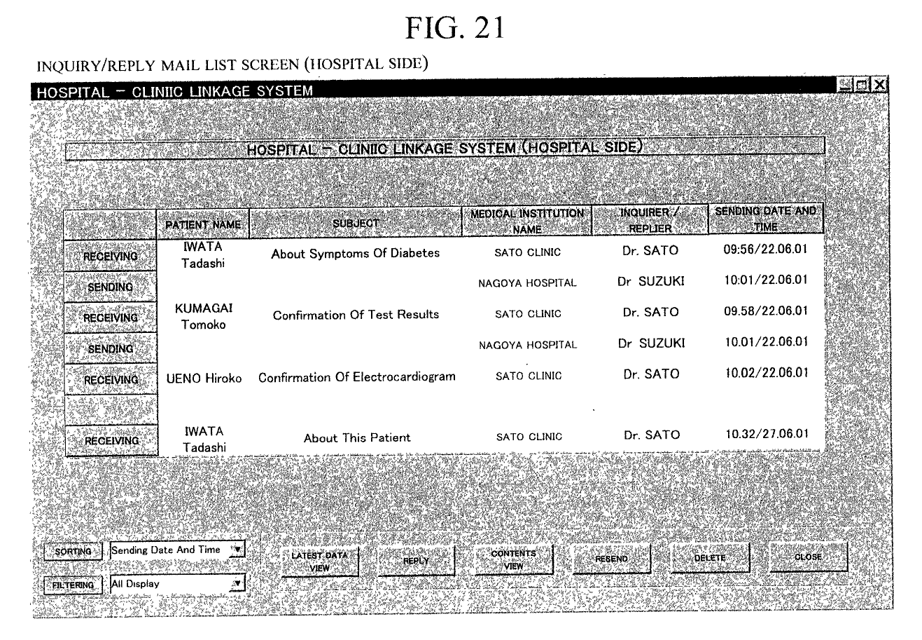

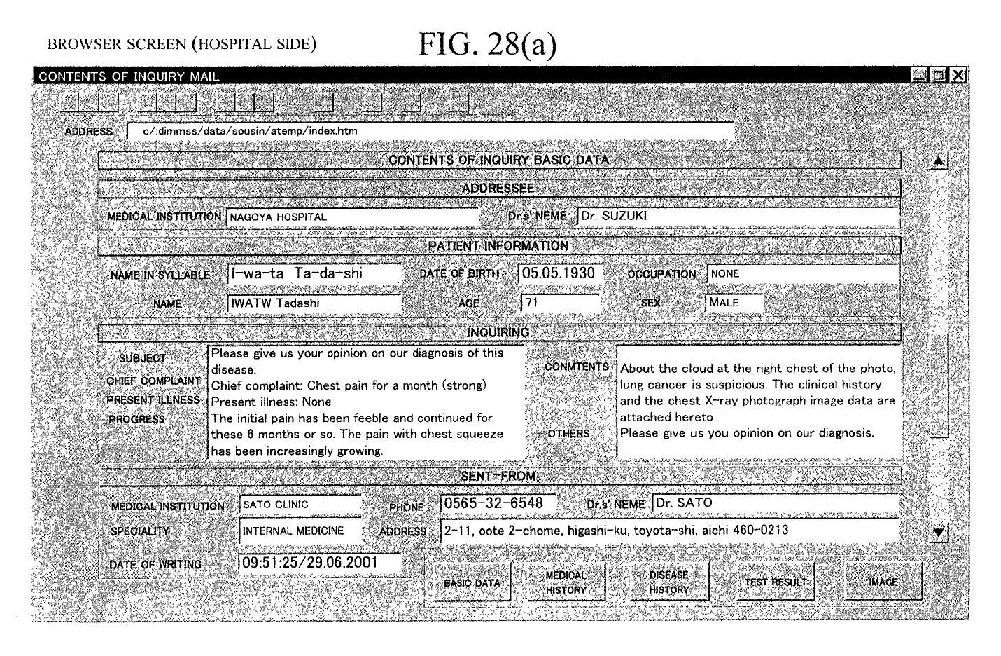

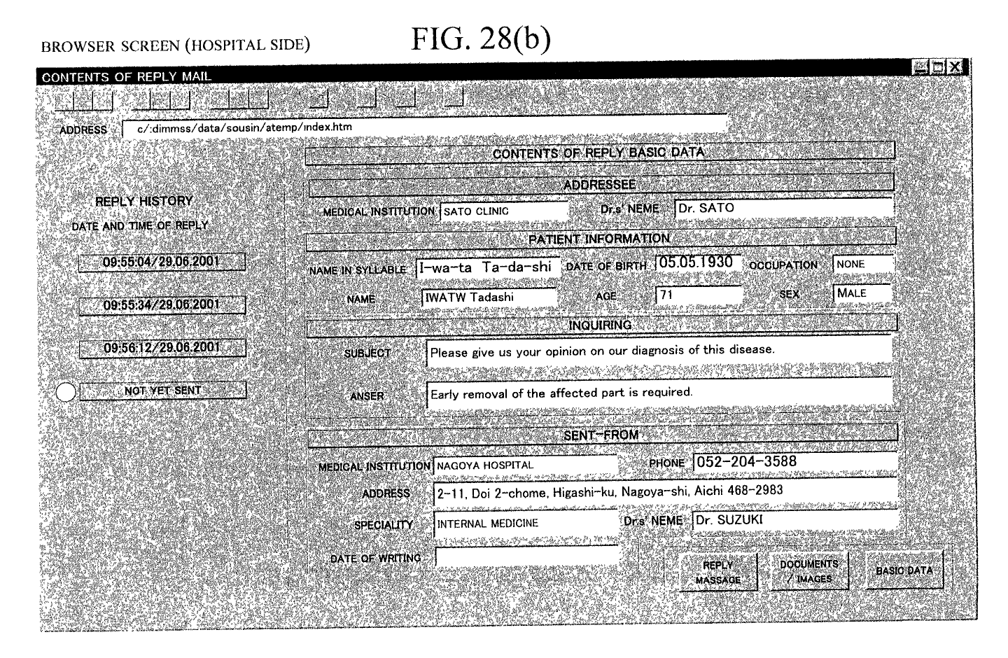

When the inquiry data is selected and the display of the contents thereof is commanded in the Inquiry/Reply Mail List screen (refer to FIG. 21) provided by the clinic linkage function, the contents of the basic data, which is included in such inquiry data, are displayed in the browser (e.g., Internet Explorer) screen, and at the same time, button switches for displaying each attachment data are displayed in the lower part of the browser screen (refer to FIG. 28(a)).

[5-3] Creation of the Reply Data (S55)

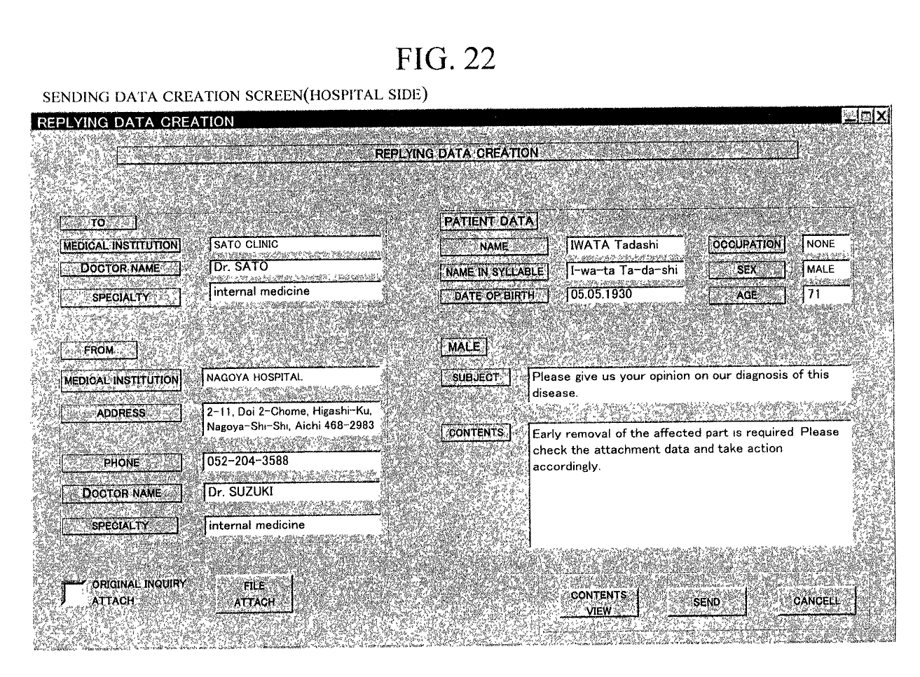

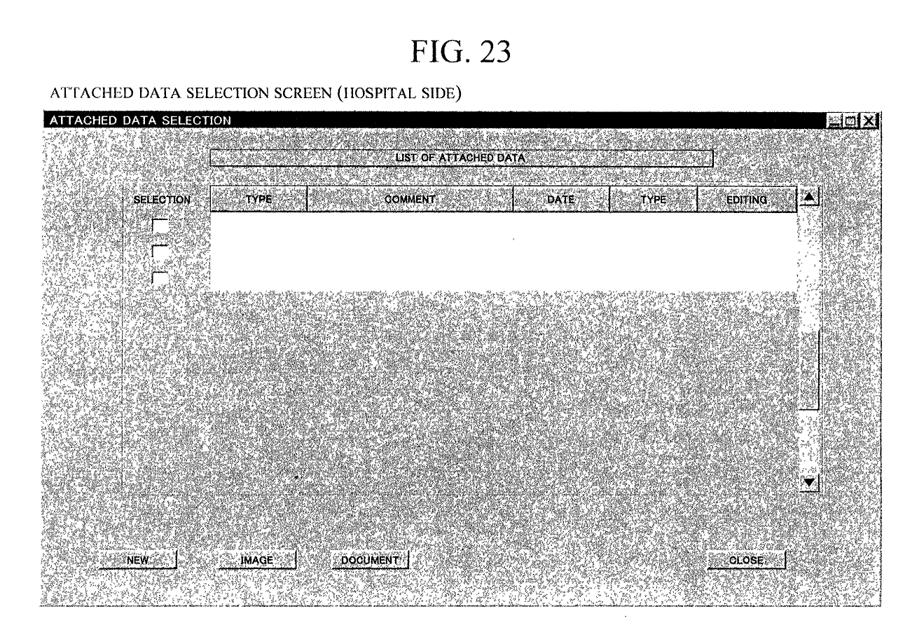

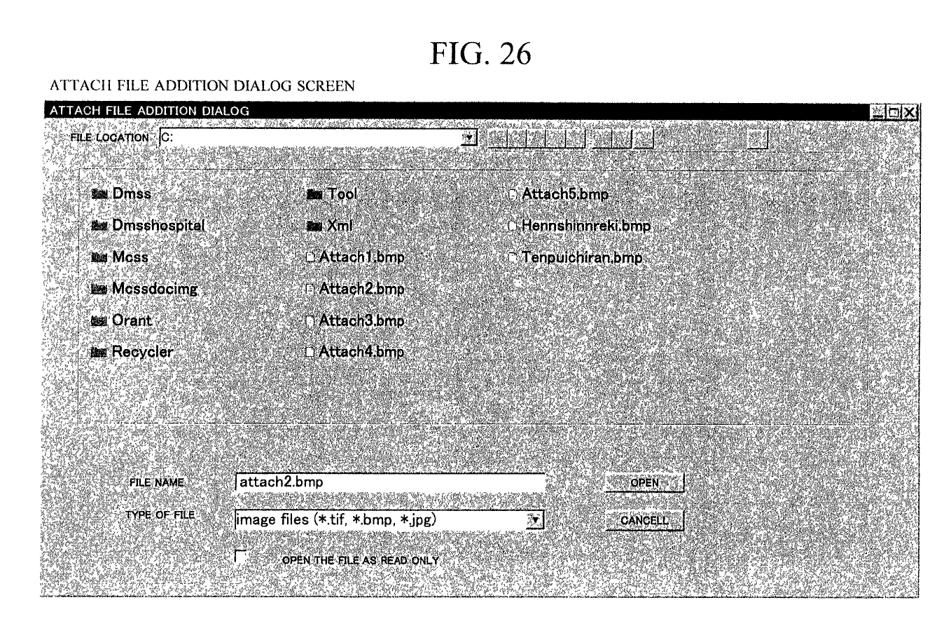

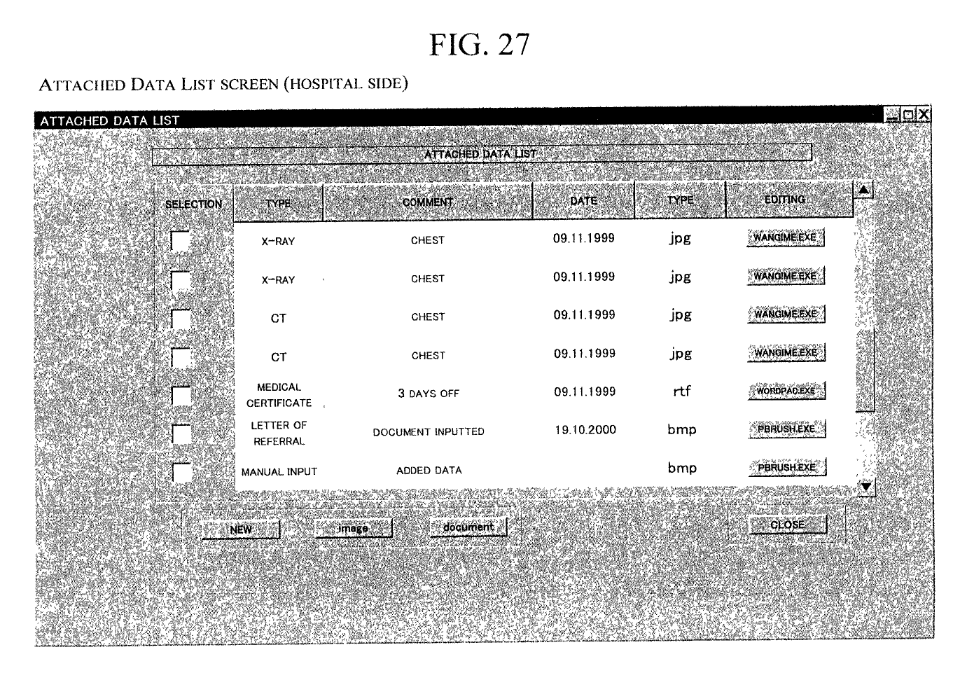

When the inquiry data is selected and the REPLY button is pressed in the Inquiry/Reply Mail List screen shown in FIG. 21, the Sending Data Creation screen shown in FIG. 22 is started. Also, when the reply data is selected and RESEND button is pressed in the Inquiry/Reply Mail List screen, the Sending Data Creation screen is started. In the Sending Data Creation screen of FIG. 22 and each screen entered from the Sending Data Creation screen, reply data is created, amended or selected. Here, the screens entered from the Sending Data Creation screen are, e.g., Attachment Data Selection screens (FIGS. 23, 24, 25, and 27), and Attachment Data Addition screen (FIG. 26). The reply data thus created and amended or selected as the need arises is saved in the memory 23. This reply data is composed of basic data and medical treatment data selected and edited as the need arises. The email of this reply data has such control data that agrees with the control data of the e-mail of the original inquiry data. Here, the control data refers to e-mail ID, subject, sent-to ID (corresponding to receiver ID of the hospital system 20 or replied-from ID of the hospital system 20 and clinic system 10), and sent-from ID (corresponding to sent-from ID of the hospital system 20, replied-to ID of the hospital system 20, or receiver ID of the clinic system 10).

[5-4] Confirmation of the Reply Data (S57)

The reply data is converted into a file of the XML format in response to operation input commanding the display of the contents. Then, the converted file is processed by using the XSL file, and the contents are displayed in the browser (e.g., Internet Explorer) screen. For example, when the display of the contents is commanded in the Sending Data Creation screen shown in FIG. 22, the contents of the basic data, which is the component of the reply data, are displayed, and at the same time, button switches for displaying the contents of each attachment data are displayed in the lower part of the browser screen (refer to FIG. 28(b)). On the other hand, when the display of the contents is commanded in one of the Attachment Data Selection screens (refer to FIGS. 23, 24, 25, and 27) to be attached to the basic data, the contents of the selected data are displayed.

[5-5] Sending of the Reply Data (S59)

The basic data and each attachment data both composing the reply data are converted into files of the XML format, respectively, in response to operation input commanding sending, compressed together, and sent as an attachment file to an e-mail to the addressee (i.e., the sender of the inquiry data). In the hospital-clinic linkage system according to this embodiment, the inquiry data and reply data thereto are controlled in pairs by having common control data of e-mails.

[6] Processing of the Inquiry Data (Clinic Side)

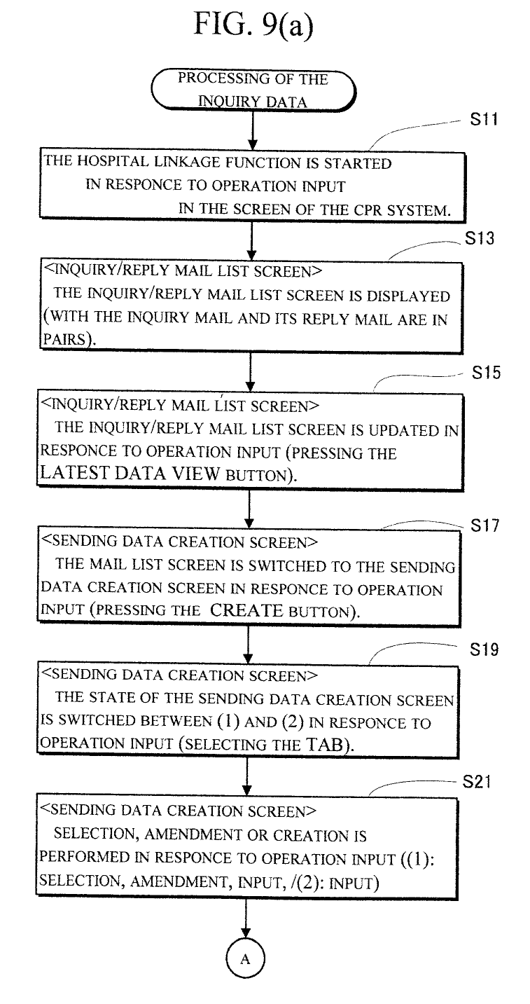

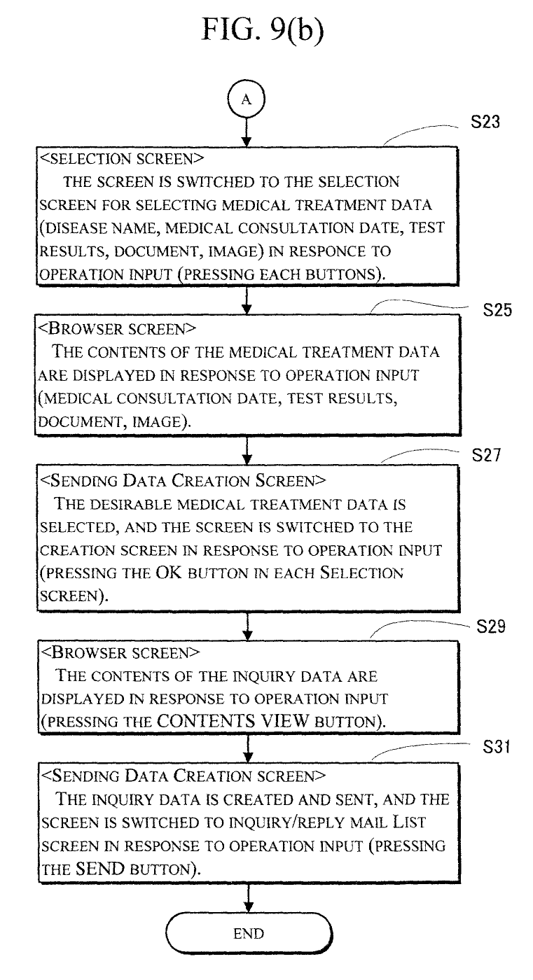

Procedure of processing the inquiry data (creation, confirmation and sending of the inquiry data) will be described referring to FIG. 9(a) and (b).

In response to the operation input in each of the screens of the CPR system function (Chart No. 2 screen, Time-Series screen, etc.,), the hospital linkage function is started (S11), and an Inquiry/Reply Mail List screen as illustrated in FIG. 11 is displayed (S13). This Inquiry/Reply Mail List screen is displayed based on the data read from the database 12b of sent data and the database 12c of received data (refer to FIG. 2). As shown in the Inquiry/Reply Mail List screen, in the hospital-clinic linkage system according to this embodiment, inquiry data and reply data thereto mutually correspondingly controlled using e-mail ID and other control data are displayed adjacent to each other in vertical arrangement.

When the LATEST DATA VIEW button is pressed in the Inquiry/Reply Mail List screen (refer to FIG. 11), the latest received data is read from the sent/received buffer 13b and recorded in the database 12c of received data. Also, the bibliographic data in this recorded data is displayed in the Inquiry/Reply Mail List screen, in other words, the display of the Inquiry/Reply Mail List screen is updated (S15).

When the CREATE button is pressed in the Inquiry/Reply Mail List screen, the screen is switched to the tab (1) state of the Sending Data Creation screen (refer to FIG. 12) to be input the basic data (1) (S17). This tab (1) state screen is switched to the tab (2) state screen to be input the basic data (2) in response to the tab switching operation. In other words, in the Sending Data Creation screen shown in FIGS. 12 and 13, the tab (1) state and the tab (2) state are switched to each other in response to the tab switching operation (S19).

The tab (1) screen for inputting the basic data (1) is designed for the selection of patient, the selection and amendment of patient data, the setting and input of addressee, and the setting and input of sender. In the patient selection column, the patient names taken from the CPR system function are selectably displayed. When only one patient name is taken from the CPR system function, such patient name is set and displayed. In the patient data column, the patient data of the selected patient is displayed. The contents of each item of the patient data can be amended and are included in the basic data when the check box of such item is checked. On the other hand, when the checking of the check box of such item is cancelled, such item is removed from the basic data, and the editing field of such item is set to Prohibit (not do) status (refer to FIG. 6), because it is not necessary to edit.

As the only one hospital is set as a reply side institution in the hospital-clinic linkage system of this embodiment, the name of such hospital's name is initially displayed in the input column of “sent-to”, and only what is required is to input the medical doctor name. However, this can be so arranged that the medical institution name is selected from among a plurality of medical institutions.

In the input columns of “sent-from”, the bibliographic items such as an address or a phone number of a clinic where the clinic system 10(i) is installed are initially displayed. As a medical doctor name, the logged-in medical doctor name is displayed. It should be noted here that the specialty (medical department) is so arranged as to be input by an operator. The selection of the above-described initial display items and the selection of the input items may be changed according to the actual situation of a medical institution where the clinic system 10(i) is installed.

In response to the pressing operation of the attached data buttons (DISEASE NAME button, CONSULTATION DATE button, TEST RESULTS button, DOCUMENT button, and IMAGE button) located in the right column of the Sending Data Creation screen, the screen is switched to the corresponding Selection screen (S23). For example, when the DISEASE NAME button is pressed, the Disease Name Selection screen (refer to FIG. 14) is displayed. When the CONSULTATION DATE button is pressed, the Medical Consultation Date Selection screen (refer to FIG. 15) is displayed. When the TEST RESULTS button is pressed, the Test Result Selection screen (refer to FIG. 16) is displayed. When the IMAGE button is pressed, the Image Selection screen (refer to FIG. 18) is displayed. When the DOCUMENT button is pressed, the Document Selection screen (refer to FIG. 19) is displayed.

In the Disease Name Selection screen (refer to FIG. 14), when the selection box is checked and then the OK button is pressed, such disease name is selected as medical treatment data to be added to the inquiry data. In the same way, in the Medical Consultation Date Selection screen (refer to FIG. 15), when the selection box is checked and the OK button is pressed, such medical consultation date (medical treatment receiving date) is selected as medical treatment data to be added to the inquiry data. When the date of each medical treatment data is clicked, the browser is started and the medical treatment data of the selected medical treatment receiving date is displayed (S25), and thereby the contents of such medical treatment data can be confirmed. In the Test Result Selection screen (refer to FIG. 16), when the desired test results are selected and then the OK button is pressed, such test results are selected as medical treatment data to be added to the inquiry data. The selection of test results is enabled in the unit of item and also in the unit of group. The range of the test results displayed in the Test Result Selection screen is specified by specifying the date range in the Date Information Input Dialog screen (refer to FIG. 17). In the Image Selection screen (refer to FIG. 18), when the selection box is checked and then the OK button is pressed, such image is selected as medical treatment data to be added to the inquiry data. When the VIEW button of each image is clicked, the preview image of the intended image is displayed (S25), and thereby the contents of the intended image can be confirmed. In the Document Selection screen (refer to FIG. 19), when the selection box is checked and then the OK button is pressed, such document is selected as medical treatment data to be added to the inquiry data. When the VIEW button of each document is clicked, the preview image of such document is displayed (S25), and thereby the contents of the intended document can be confirmed.

In response to pressing of the OK button in each above-described screen, that is, pressing the OK button in the Disease Name Selection screen (refer to FIG. 14), pressing the OK button in the Medical Consultation Date Selection screen (refer to FIG. 15), pressing the OK button in the Test Results Selection screen (refer to FIG. 16), pressing the OK button in the Image Selection screen (refer to FIG. 18), or pressing the OK button in the Document Selection screen (refer to FIG. 19), the screen returns to the Sending Data Creation screen (refer to FIG. 12) (S27).

When the CONTENTS VIEW button located in the lower part of the Sending Data Creation screen (refer to FIGS. 12 and 13) is pressed, the browser is started, the contents of the basic data set in the tab (1) state screen and the tab (2) state screen are displayed, and the button switches for displaying the attached data selected in each above-described selection screen are displayed, respectively, in the lower part of the screen (S29, refer to FIG. 20(a)).

When the SEND button is pressed in the Sending Data Creation screen (refer to FIGS. 12 and 13), the basic data set in the tab (1) state screen and the tab (2) state screen, and the attached data thereto selected in such screens are converted into files of the XML format, respectively, compressed together, attached as an attachment file to an e-mail, and sent out to the Internet for further sending to the addressee (S31). It should be noted here that the hospital-clinic linkage system according to this embodiment uses a security method of Virtual Private Network (VPN) to hold the security, but any other security method may be used instead. Upon sending the inquiry data, the screen is switched to the Inquiry/Reply Mail List screen (refer to FIG. 11).

[7] Processing of the Reply Data (Hospital Side)

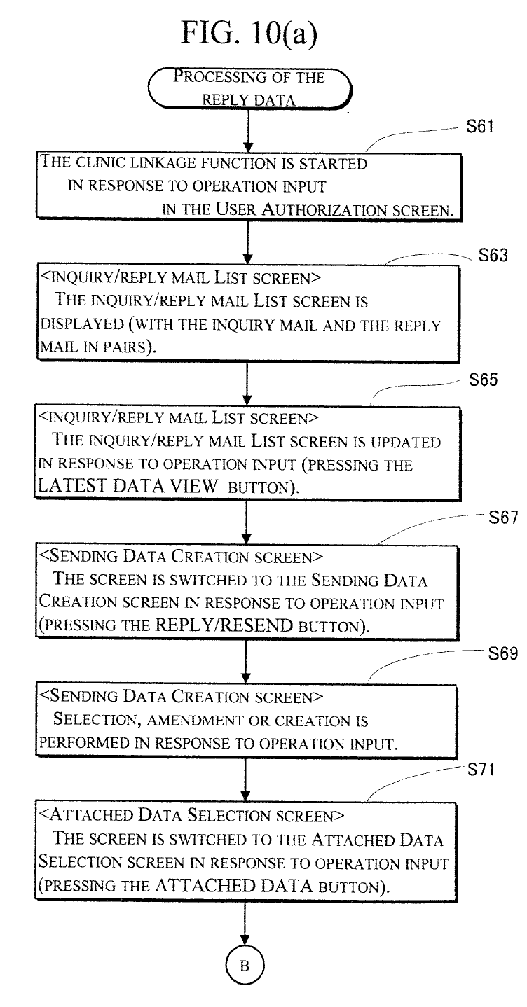

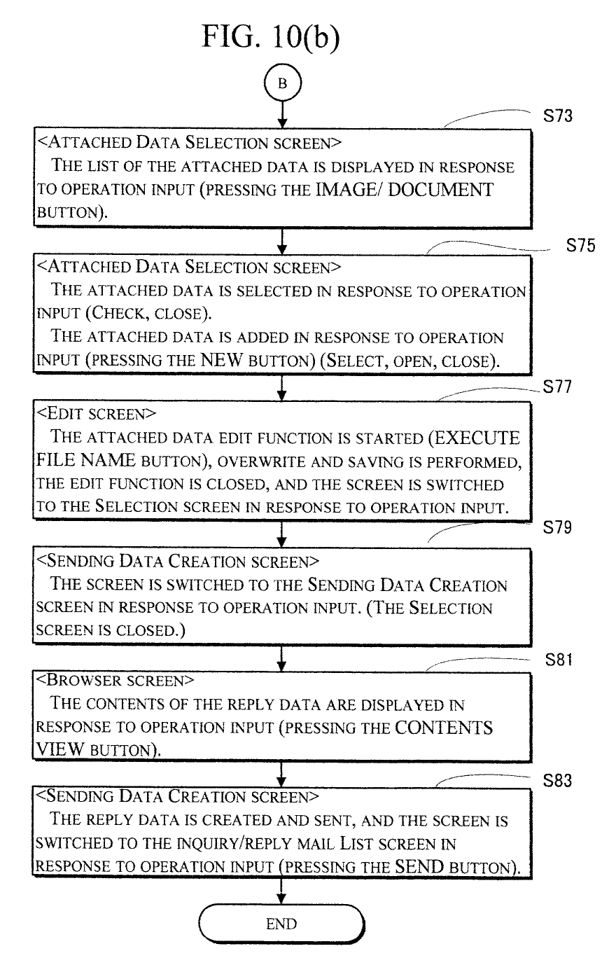

Procedure of processing the reply data (creation, confirmation and sending of the reply data) will be described referring to FIG. 10.

In response to the selection operation and correct password input in the User Authorization screen, the clinic linkage function is started (S61), and the Inquiry/Reply Mail List screen as illustrated in FIG. 21 is displayed (S63). This display is performed based on the data read from the database 22b of sent data and the database 22c of received data (refer to FIG. 3). As shown in the Inquiry/Reply Mail List screen (refer to FIG. 21), in the hospital-clinic linkage system of this embodiment, the inquiry data and the reply data thereto mutually correspondingly controlled using the e-mail ID and other control data are displayed adjacent to each other in vertical arrangement.

When the LATEST DATA VIEW button is pressed in the Inquiry/Reply Mail List screen (refer to FIG. 21), the latest received data is taken from the sent/received buffer 23b and recorded in the database 22c of received data. Also, the bibliographic data in this recorded data is displayed in the Inquiry/Reply Mail List screen, in other words, the display of the Inquiry/Reply Mail List screen is updated (S65).

When unanswered inquiry data (inquiry data with no reply data which agrees therewith on the e-mail ID and other control data) is selected and the REPLY button is pressed in the Inquiry/Reply Mail List screen (refer to FIG. 21), the screen is switched to the Sending Data Creation screen (refer to FIG. 22) (S67). Also, when already answered reply data is selected and RESEND button is pressed in the Inquiry/Reply Mail List screen, the screen is switched to the Sending Data Creation screen (refer to FIG. 22) (S67).

In the former case, data based on the unanswered inquiry data is displayed in the addressee, patient data and subject columns, and the reply contents column is empty in the first place. On the other hand, in the latter case, the same data as the already answered reply data is displayed in the addressee, patient data and subject columns, and the previous reply contents are copied as they are to the reply contents column in the first place. It should be noted here that in both cases, in the input columns of “from”, the bibliographic items such as an address or a phone number of a hospital where the hospital system 20 is installed are initially displayed. As a medical doctor name, the logged-in medical doctor name is displayed.

In the reply contents column of the Sending Data Creation screen (refer to FIG. 22), input, amendment or addition is performed as the need arises (S69). When the check box of “Original Inquiry Attach” is checked, the basic data, which is displayed in the Sending Data Creation screen, of the original inquiry data is attached to the basic data of the reply mail.

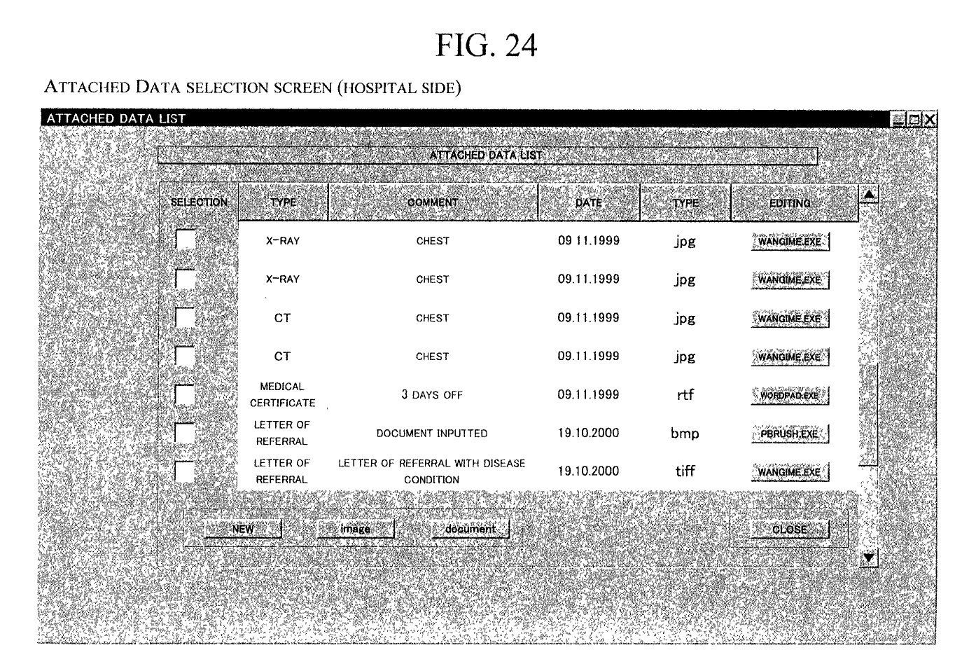

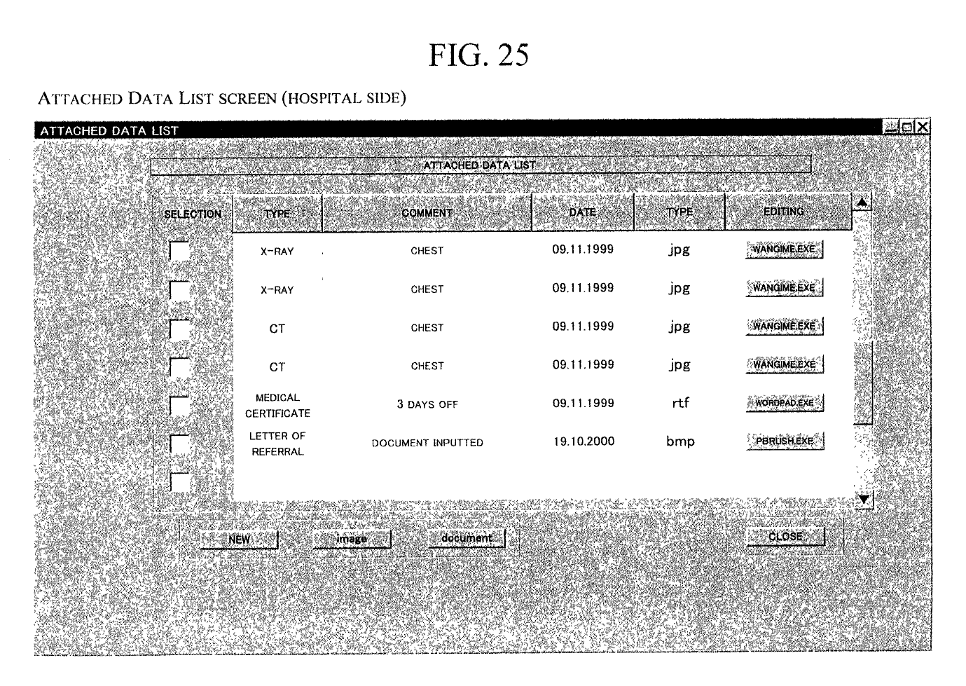

When the FILE ATTACH button located in the lower left part of the Sending Data Creation screen is pressed, the screen is switched to the Attached Data Selection screen (refer to FIG. 23) (S71). When the IMAGE button located in the lower part of the Attached Data Selection screen (refer to FIG. 23) is pressed, the image data attached to the original inquiry mail is displayed in list as shown in the upper half part of FIG. 24 (S73). When the DOCUMENT button located in the lower part of the Attached Data Selection screen (refer to FIG. 23 or 24) is pressed, the document data attached to the original inquiry mail is added to the image data list and displayed in list as shown in the lower half part of FIG. 24 (S73). These image data and document data can be edited as the need arises by clicking the EXECUTE button located in the right end column of such image data line and document data line and thereby starting a related edit application (application for image edit, application for document edit) (S77). Such image data and document data can be made attached data to the reply data by checking the check box of such image data line and document data line (refer to FIG. 25) and closing the Attached Data Selection screen (S75).

On the other hand, when the NEW button located in the lower part of the Attached Data Selection screen (refer to FIG. 23, 24, 25, or 27) is pressed, the screen is switched to the screen (Attach File Addition Dialog screen, refer to FIG. 26) for adding the new data (S75). By selecting the desired data in this screen, even the data not attached to the original inquiry data can be added to the reply data (S75). It is of course that this data can be edited in the same way as the above-described image data and document data (S77).

When the Attached Data Selection screen is closed, the selected attached data is saved in the memory 23, and the screen returns to the Sending Data Creation screen (refer to FIG. 22) (S79).

When the CONTENTS VIEW button is pressed in the Sending Data Creation screen (refer to FIG. 22), the browser is started, the contents of the basic data, which is set in the Sending Data Creation screen, are displayed, and at the same time, button switches for displaying the attached data selected in each selection screen are displayed, respectively, in the lower part of the browser screen (S81, refer to FIG. 28(b)).

When the SEND button is pressed in the Sending Data Creation screen (refer to FIG. 22), the basic data displayed in the Sending Data Creation screen and the attached data thereto selected in the Attached Data Selection screen are converted into files of the XML format, respectively, compressed together, attached to an e-mail with the control data same as the control data of the original inquiry data as an attachment file, and sent out to the Internet for further sending to the clinic system 10(i) as the addressee (the sender of the inquiry data). Upon sending the reply data, the screen is switched to the Inquiry/Reply Mail List screen (refer to FIG. 21).

[8] Other Embodiments

In the above, this invention has been described referring to a system to be used for medical treatment acts at comparatively small-sized clinics in which a comparatively small-sized medical institution (i.e., clinic) sends an inquiry data to a comparatively large-sized medical institution (i.e., hospital) and receives a reply data from the hospital, that is a hospital-clinic linkage system. However, this invention should not be limited to such system alone but may be applied to such a system that aims at medical treatment of higher level by exchanging opinions between equivalent medical institutions and such a system that a hospital playing a central role in an area can receive reference material from each clinic within the same area for the purpose of epidemiological investigation and others. Here, the “reference material” refers to such reference material as one related to the occurrence mode of a specific disease. In such reference material, only age and sex, for example, may be required as patient data included in the basic data.

Also in the above description, the inquiry data and the reply data thereto are controlled in correspondence with the e-mail ID, subject, sent-to ID and sent-from ID. However, the correspondence between the inquiry data and the reply data thereto should not be limited to these control data but may use other data or a combination of any of the above data with other data. In short, any data may be used for correspondence as long as control can be achieved between the inquiry data and the reply data thereto.

Also, in the above description, this invention has been described referring to inquiries and replies between fixed medical institutions. However, at least one party may be a vehicle (ambulance car, ambulance helicopter, ambulance ship, medical treatment room in a ship, etc.) provided that such vehicle and the Internet is wirelessly connected. Also, for medical institutions engaged in emergency medical treatment, the medical treatment data to be sent may be images photographed on the spot or the like instead of the medical treatment data recorded in a hard disk.

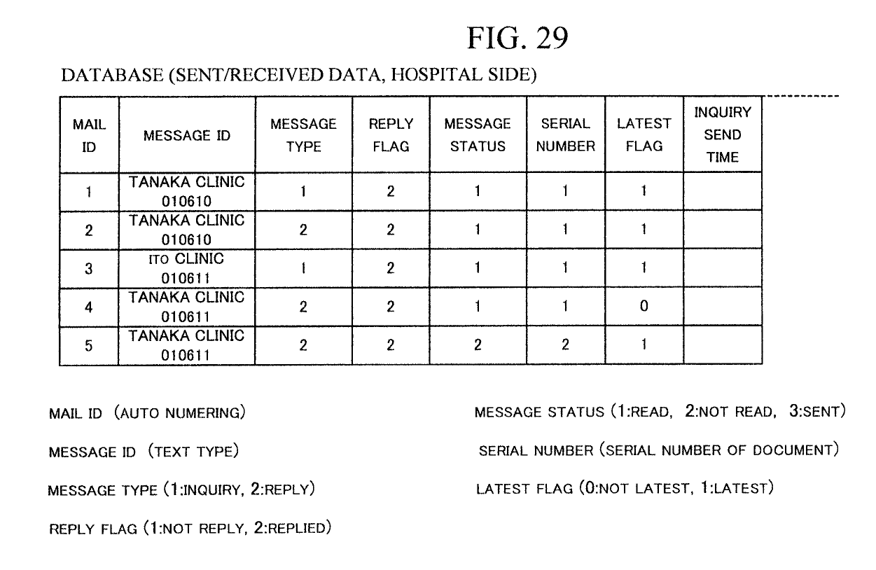

Also, in the above embodiment, the clinic system 10 controls the record of the database 12b of sent data and the record of the database 12c of received data corresponding thereto in correspondence with the e-mail ID, subject, sent-to ID (corresponding to sent-from ID) and sent-from ID (corresponding to receiver ID) as a combined key as shown in FIG. 4, while the hospital system 20 controls the record of the database 22b of sent data and the record of the database 22c of received data corresponding thereto in correspondence with the e-mail ID, subject, replied-to ID (corresponding to sent-from ID) and replied-from ID (corresponding to receiver ID) as a combined key as shown in FIG. 5. However, this invention should not be limited to a specific composition of database but may employ such a composition of the database of the hospital system 20 as shown in FIG. 29, that is, the database may be so composed that control is performed by corresponding the message ID (text type data), message type (numeric type data (1: inquiry, 2: reply)), replied flag (numeric type data (1:unreplied, 2:replied)), message status (numeric type data (1: read, 2: unread, 3: sent)), serial number (numeric type data), latest flag (numeric type data (0: not latest, 1: latest)), etc. to the unique Mail ID. Here, it is so assumed that the database of the clinic system 10 is also composed in the same way in correspondence with the database of the hospital system 20 so configured as shown in FIG. 29.

Parts List

10(1), 10(2), . . . , 10(i) clinic system

20 hospital system

90 the Internet

12a database of medical treatment and patient data

12b database of sent data

12c database of received data

13a patient data table

22b database of sent data

22c database of received data

23a sent/received buffer

We claim:

1. A linkage system which links a first computer of a first medical institution with a second computer of a second medical institution through a network,
wherein the first computer of the first medical institution comprising:
a communication terminal for sending out an e-mail to the network and receiving an e-mail from the network;
an inquiry file creating means for creating an inquiry basic data file having a patient information and inquiry contents;
an inquiry mail creating means for creating an e-mail having the inquiry basic data file as an attachment file thereto and addressing to the second computer;
a reply contents output means for outputting reply contents being included in an attachment file of a received e-mail in a predetermined mode; and
wherein the second computer of the second medical institution comprising:
a communication terminal for sending out an e-mail to the network and receiving an e-mail from the network;
an inquiry contents output means for outputting inquiry contents being included in an attachment file of a received e-mail in a predetermined mode;
a reply file creating means for creating a reply basic data file having an answer to the outputted inquiry contents; and
a reply mail creating means for creating an e-mail having the reply basic data file as an attachment file thereto and addressing to the first computer.

2. A linkage system according to claim 1,
wherein the inquiry file creating means further creating a medical data file based on a medical data of the patient specified by the patient information, and
wherein the inquiry mail creating means creating the e-mail further having the medical data file as an attachment file thereto.

3. A linkage system according to claim 2,
wherein the second computer further comprising a data extracting means for extracting medical data from the medical data file being attached to the received e-mail,
and wherein the reply file creating means further creating a reply attached data file based on the extracted medical data,
and wherein the reply mail creating means creating the e-mail further having the reply attached data file as the attachment file thereto.

4. A linkage system according to claim 3,
wherein the second computer further comprising an data editing means for editing the extracted medical data,
and wherein the reply file creating means creating the reply attached data file based on the edited medical data.

5. A linkage system according to claim 1, wherein the first computer further comprising:
a patient data item selecting means for designating each patient data item to be given to the inquiry file creating means as the patient information; and
a patient data item revising means for revising the contents of the designated patient data item.

6. A computer of a medical institution in a linkage system which links computers to each other through a network, the computer of the medical institution comprising:
a communication terminal for sending out an e-mail to the network and receiving an e-mail from the network;
an inquiry file creating means for creating an inquiry basic data file having a patient information and inquiry contents and a medical data file based on a medical data of the patient specified by the patient information; and
an inquiry mail creating means for creating an e-mail having the inquiry basic data file and the medical data file as attachment files thereto and addressing to a predetermined computer of another medical institution in the linkage system.

7. A computer of a medical institution according to claim 6, wherein the computer of the medical institution further comprising:
a patient data item selecting means for designating each patient data item to be given to the inquiry file creating means as the patient information; and
a patient data item revising means for revising the contents of the designated patient data item.

8. A computer program which allows a computer in a linkage system of computers of medical institutions being linked to each other through a network to function as:
an inquiry file creating means for creating an inquiry basic data file having a patient information and inquiry contents and a medical data file based on a medical data of the patient specified by the patient information; and
an inquiry mail creating means for creating an e-mail having the inquiry basic data file and the medical data file as attachment files thereto and addressing to a predetermined computer of another medical institution in the linkage system.

9. A computer of a medical institution in a linkage system which links computers to each other through a network, the computer of the medical institution comprising:
a communication terminal for sending out an e-mail to the network and receiving an e-mail from the network;
an inquiry contents output means for outputting inquiry contents being included in an attachment file of a received e-mail in a predetermined mode;
a reply file creating means for creating a reply basic data file having an answer to the outputted inquiry contents; and
a reply mail creating means for creating an e-mail having the reply basic data file as an attachment file thereto and addressing to a predetermined computer of another medical institution in the linkage system.

10. A computer of a medical institution according to claim 9,
wherein the computer further comprising a data extracting means for extracting medical data from the medical data file being attached to the received e-mail,
and wherein the reply file creating means further creating a reply attached data file based on the extracted medical data,
and wherein the reply mail creating means creating the e-mail further having the reply attached data file as the attachment file thereto.

11. A computer of a medical institution according to claim 10,
wherein the computer further comprising an data editing means for editing the extracted medical data,
and wherein the reply file creating means creating the reply attached data file based on the edited medical data.

12. A computer program which allows a computer in a linkage system of computers of medical institutions being linked to each other through a network to function as:
an inquiry contents output means for outputting inquiry contents being included in an attachment file of a received e-mail in a predetermined mode;
a reply file creating means for creating a reply basic data file having an answer to the outputted inquiry contents; and
a reply mail creating means for creating an e-mail having the reply basic data file as an attachment file thereto and addressing to a predetermined computer of another medical institution in the linkage system.

13. A linkage system which links a first computer of a first medical institution with a second computer of a second medical institution through a network,
wherein the first computer of the first medical institution comprising:
a communication terminal for sending out an e-mail to the network and receiving an e-mail from the network;
an inquiry mail creating means for creating an e-mail having the inquiry basic data file of a patient information and inquiry contents as an attachment file thereto and addressing to the second computer;
a mail control data setting means for setting an unique control data to the created inquiry e-mail;
a mail control means for controlling e-mails in pairs, the e-mails being set corresponding control data respectively; and
wherein the second computer of the second medical institution comprising:
a communication terminal for sending out an e-mail to the network and receiving an e-mail from the network;
a reply mail creating means for creating an e-mail having the reply basic data file of an answer to the inquiry contents as an attachment file thereto and addressing to the first computer;
a mail control data setting means for setting a control data being created correspondingly by the control data of the inquiry e-mail to the created reply e-mail; and
a mail control means for controlling e-mails in pairs, the e-mails being set corresponding control data respectively.

14. A linkage system according to claim 13, wherein the inquiry e-mail created by the inquiry mail creating means further having a medical data file as an attachment file thereto.

15. A method of linking a first computer of a first medical institution with a second computer of a second medical institution through a network,
wherein the first computer of the first medical institution executing procedures comprising the steps of:
creating an inquiry basic data file having a patient information and inquiry contents;
creating an e-mail having the inquiry basic data file as an attachment file thereto;
sending out the created e-mail to the network addressing to the second computer; and
wherein the second computer of the second medical institution executing procedures comprising the steps of:
outputting inquiry contents being included in an attachment file of a received e-mail in a predetermined mode;
creating a reply basic data file having an answer to the outputted inquiry contents;
creating an e-mail having the reply basic data file as an attachment file thereto; and
sending out the created e-mail to the network addressing to the first computer.
